(19) United States
(12) Patent Application Publication
(10) Pub. No.: US 2026/0110542 A1
(43) Pub. Date: Apr. 23, 2026

(54) USER INTERFACES FOR CREATING AND NAVIGATING PREDEFINED ROUTES

(71) Applicant: Apple Inc., Cupertino, CA (US)

(72) Inventors: Kevin N. EUGENE, San Francisco, CA (US); Kirill NEGODA, San Jose, CA (US); Leo Emile Jean Pierre VALLET, Los Angeles, CA (US); Nathaniel G. SLAUGHTER, IV, Cupertino, CA (US); William N. DANNER, Santa Cruz, CA (US)

(21) Appl. No.: 19/222,492

(22) Filed: May 29, 2025

Related U.S. Application Data
(60) Provisional application No. 63/657,681, filed on Jun. 7, 2024.
(60) Provisional application No. 63/668,614, filed on Jul. 8, 2024.

(51) Int. Cl. G01C 21/34; G01C 21/36

(52) U.S. Cl. CPC G01C 21/3415; G01C 21/3614; G01C 21/3617; G01C 21/362

(57) ABSTRACT

In some embodiments, an electronic device navigates the electronic device back to a predefined route when the electronic device determines that the current location of the electronic device is off route. In some embodiments, an electronic device provides different navigation directions in accordance with where the current location of the electronic device is relative to a start of a predefined route. In some embodiments, an electronic device displays one or more user interfaces to generate a predefined route.

### CROSS-REFERENCE TO RELATED APPLICATIONS

This application claims the benefit of U.S. Provisional Application No. 63/668,614, filed Jul. 8, 2024, and U.S. Provisional Application No. 63/657,681, filed Jun. 7, 2024, the contents of which are herein incorporated by reference in their entireties for all purposes.

### FIELD OF THE DISCLOSURE

This disclosure relates generally to an electronic device presenting user interfaces for creating and navigating predefined routes.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to create and navigate along a predefined route. The user may therefore desire efficient ways of creating and navigating predefined routes.

### SUMMARY OF THE DISCLOSURE

Providing efficient ways of providing navigation directions from a location that is not on a first predefined route back onto the first predefined route provides quick and efficient access to relevant content without the need for additional inputs and thereby reducing erroneous inputs to the electronic device to navigate to a destination location. Automatically providing an option to provide directions to navigate a user on a predefined route if the current location of the electronic device is within a threshold distance provides quick and efficient access to relevant content without the need for additional inputs and thereby reducing erroneous inputs to the electronic device to navigation on a predefined route. Adding waypoints to a known path at a first zoom level and at the location of the input at the second zoom level provides a quick and efficient way to create a predefined route, thereby reducing erroneous inputs to the electronic device.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6H illustrate exemplary ways in which an electronic device navigates on a predefined route in accordance with some embodiments of the disclosure.

FIG. 7 illustrates a flow diagram illustrating a method in which an electronic device navigates on a predefined route in accordance with some embodiments of the disclosure.

FIGS. 8A-8V illustrate exemplary ways in which an electronic device creates and navigates to a predefined route in accordance with some embodiments of the disclosure.

FIG. 9 illustrates a flow diagram illustrating a method in which an electronic device provides navigation directions based on the current location of the electronic device to the start of a predefined route according to some embodiments of the disclosure.

FIG. 10 illustrates a flow diagram illustrating a method in which an electronic device displays one or more user interfaces to generate a predefined route in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Providing efficient ways of providing directions to navigate a user that is off route back onto the first predefined route provides quick and efficient access to relevant content without the need for additional inputs and thereby reducing erroneous inputs to the electronic device to navigate to a destination location. Automatically providing an option to provide directions to navigate a user on a predefined route if the current location of the electronic device is within a threshold distance provides quick and efficient access to relevant content without the need for additional inputs and thereby reducing erroneous inputs to the electronic device to navigation on a predefined route. Adding waypoints to a known path at a first zoom level and at the location of the input at the second zoom level provides a quick and efficient way to create a predefined route, thereby reducing erroneous inputs to the electronic device.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting[ the stated condition or event]” or “in response to detecting[ the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

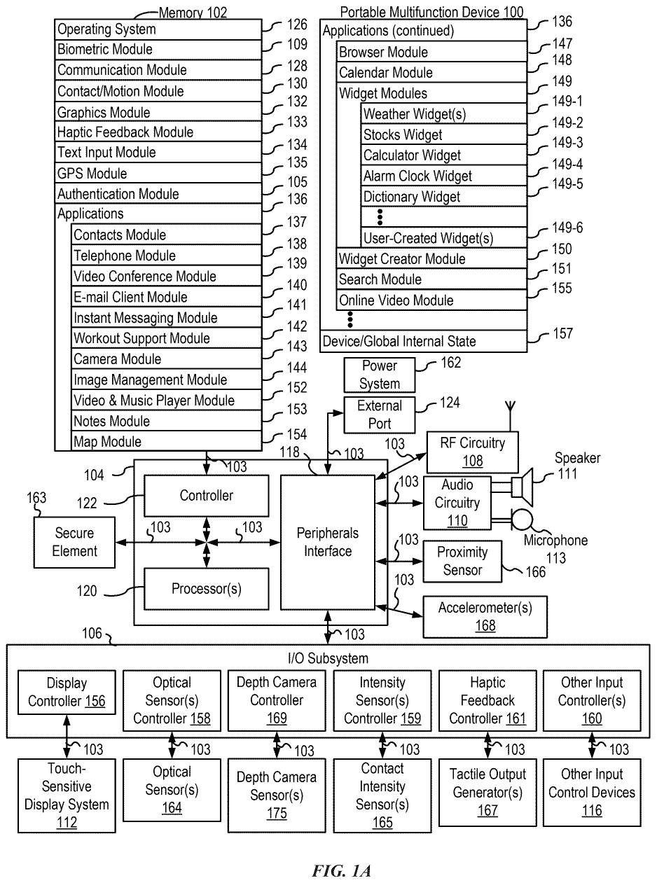

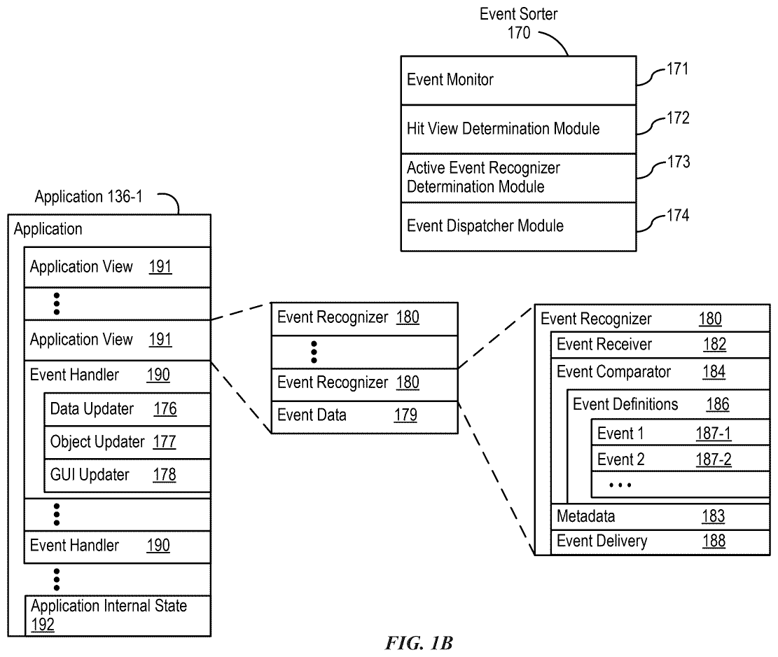

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device.

For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

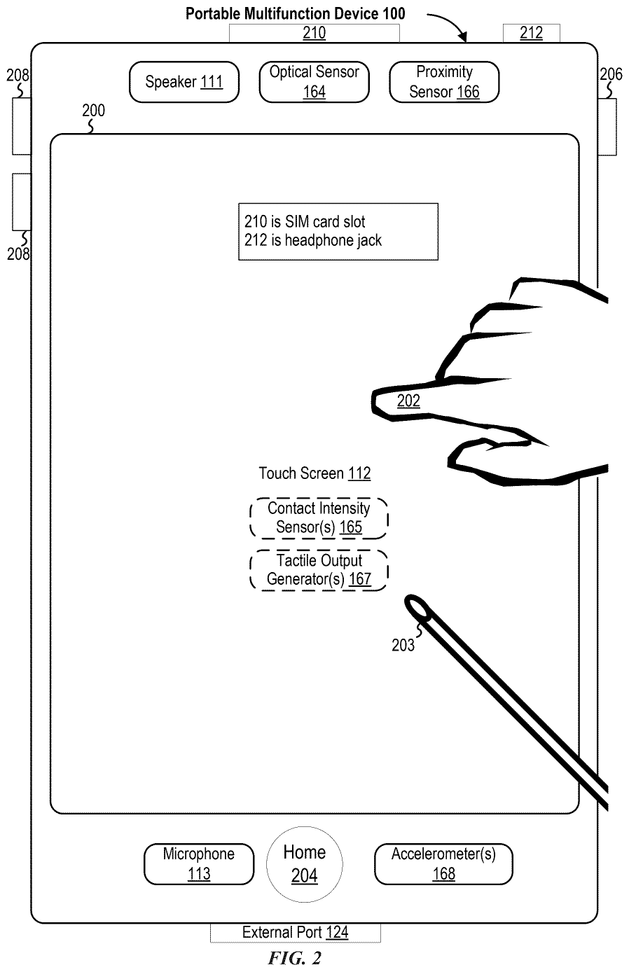

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No.: 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/48,264, “Gestures For Touch Sensitive Input Devices,” filed Jan. 31, 2005; (5) U.S. patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

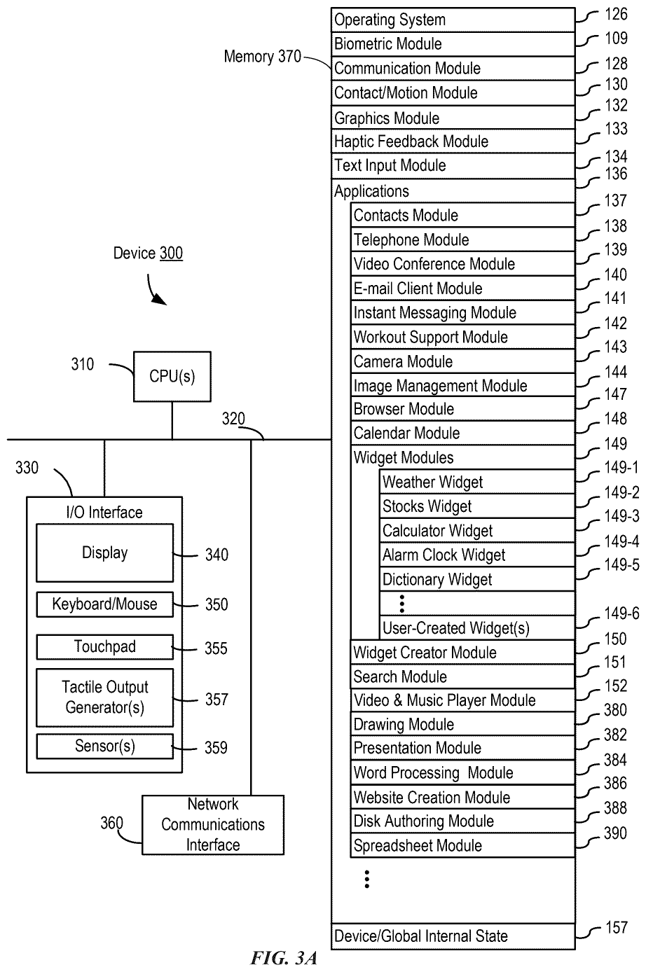

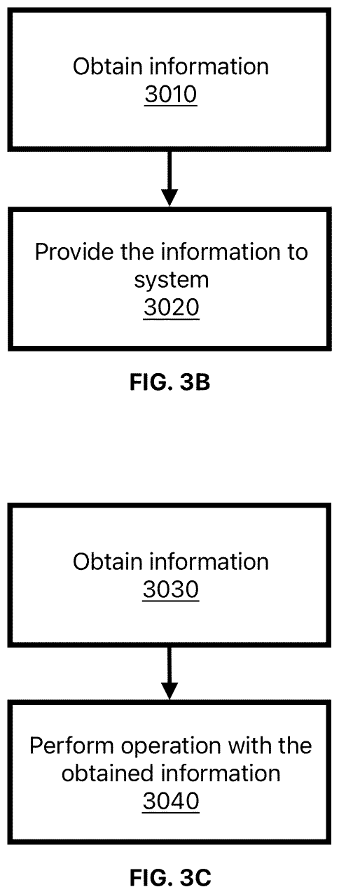

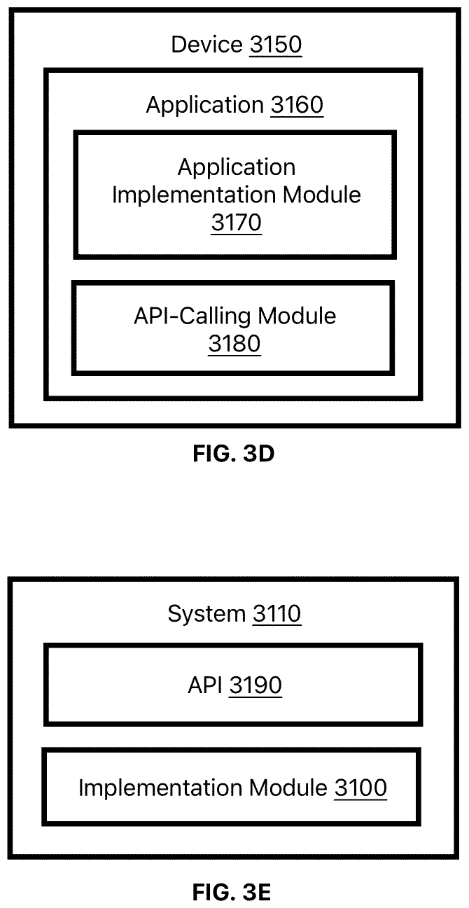

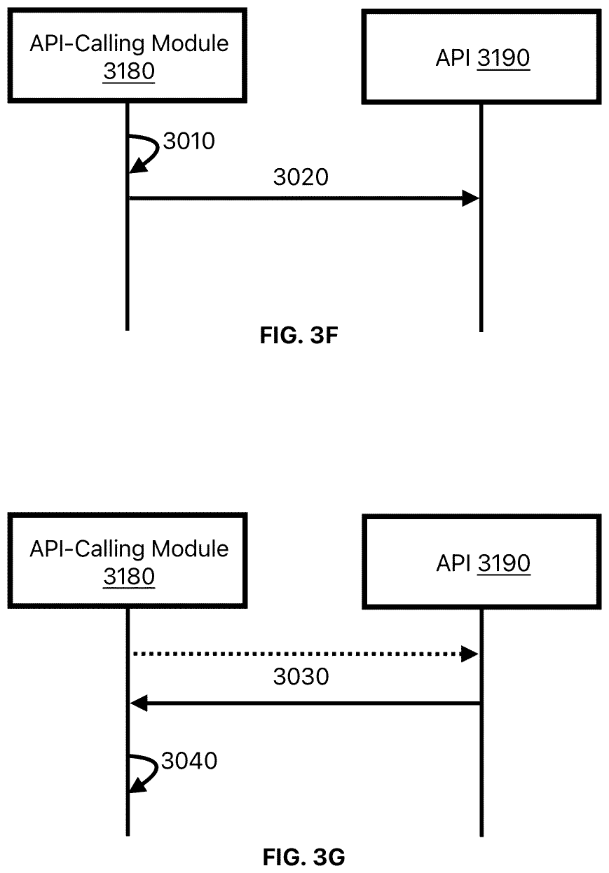

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as Vx Works) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562 , “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

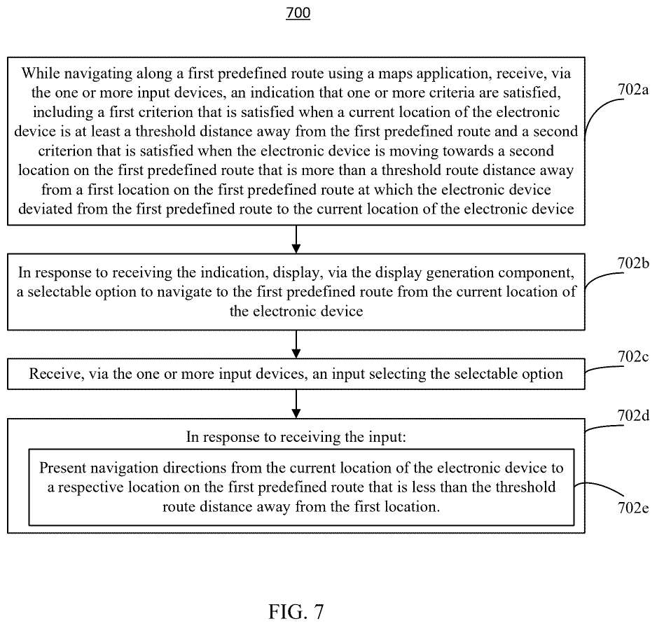

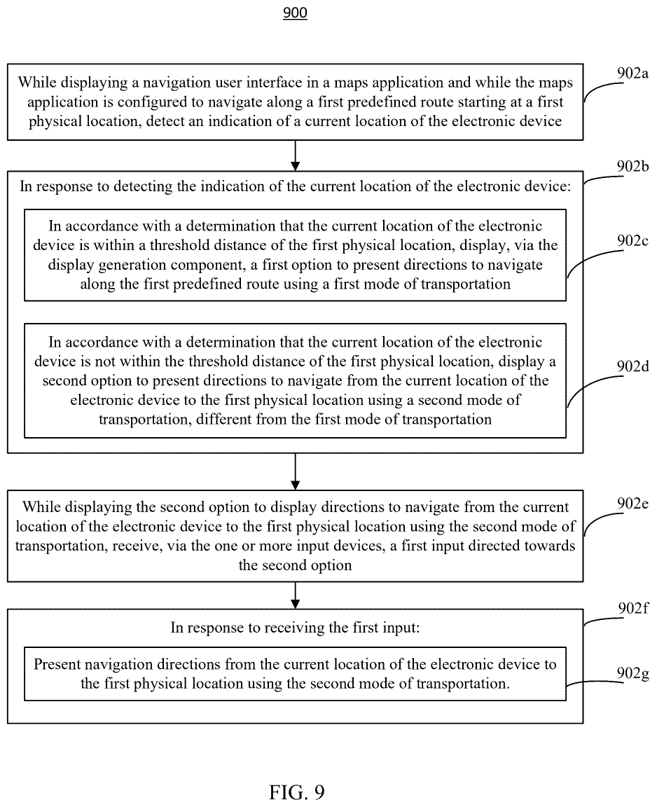

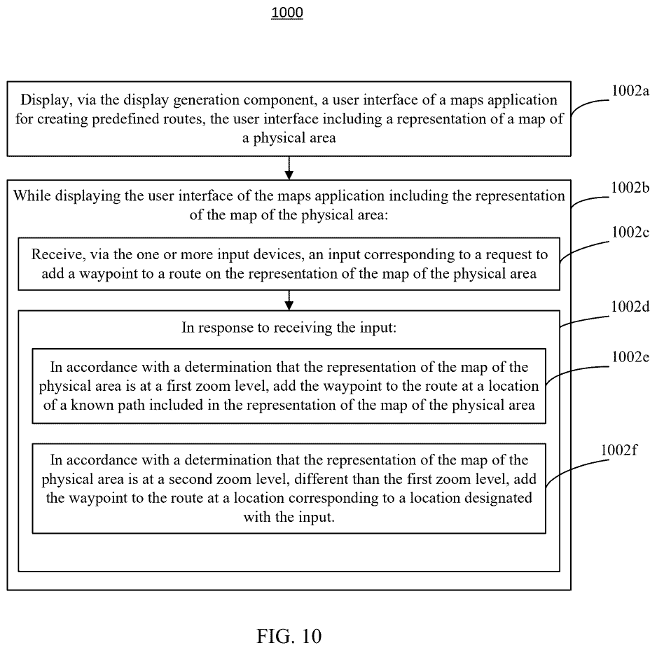

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7), method 900 (FIG. 9), and method 1000 (FIG. 10) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

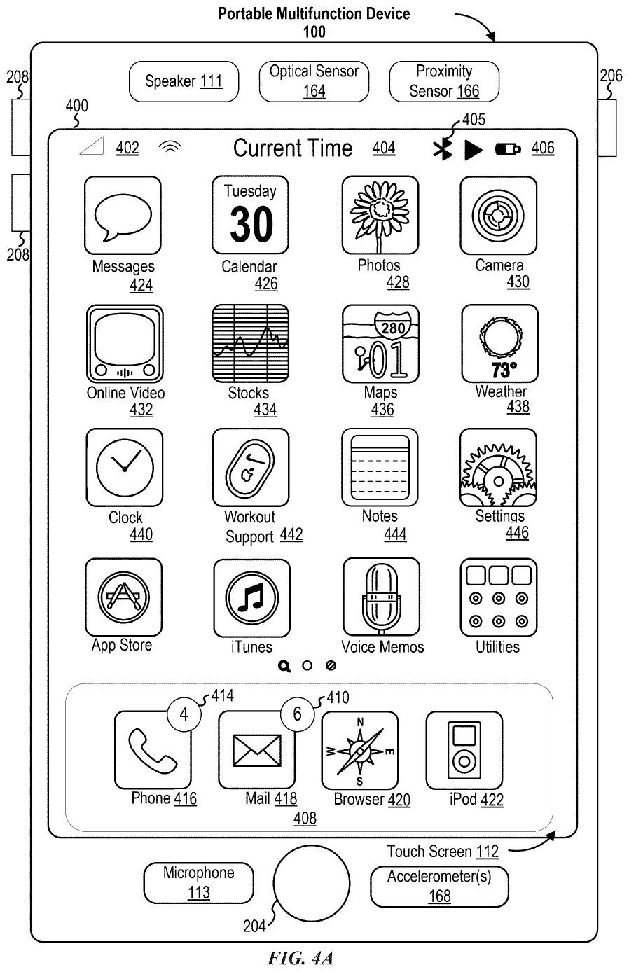

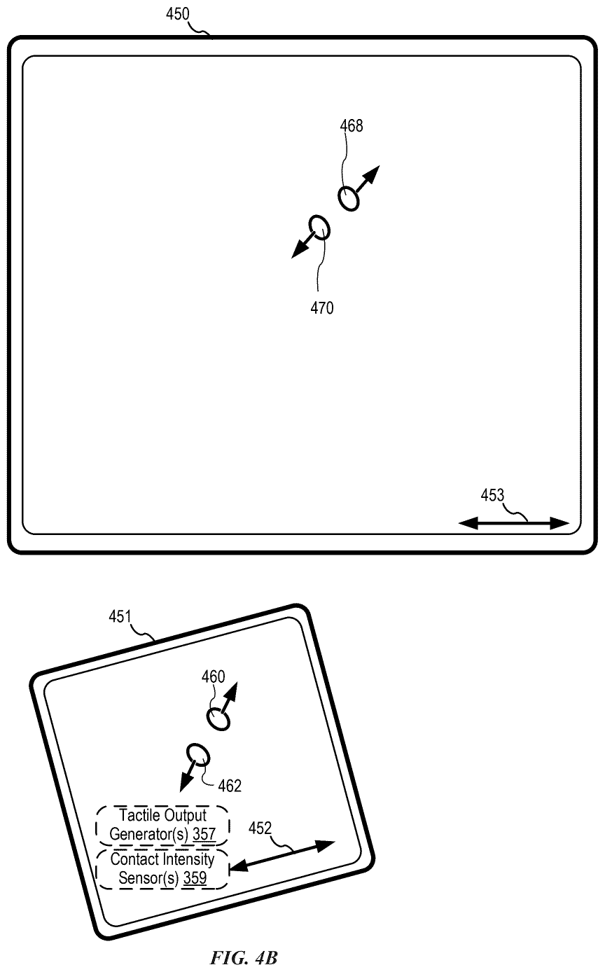

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIGS. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

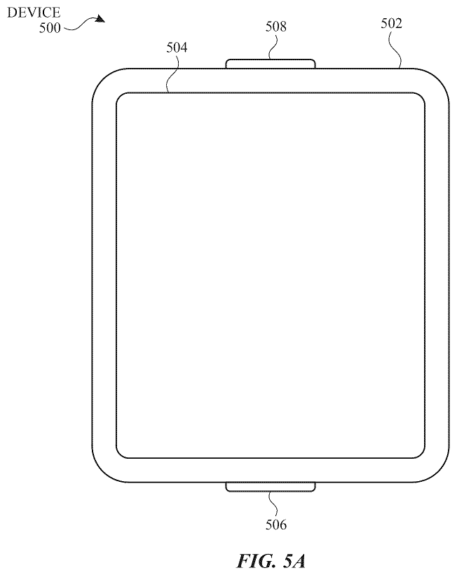

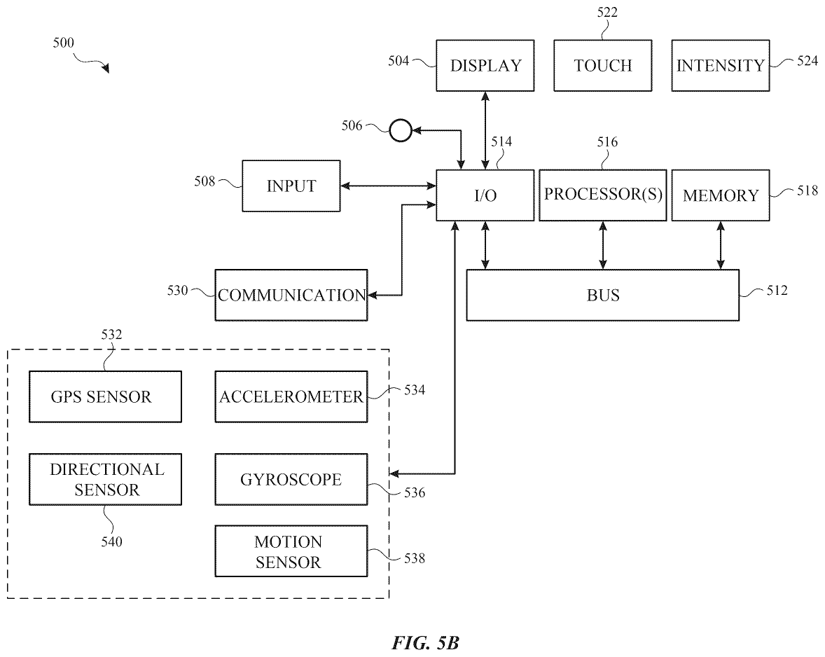

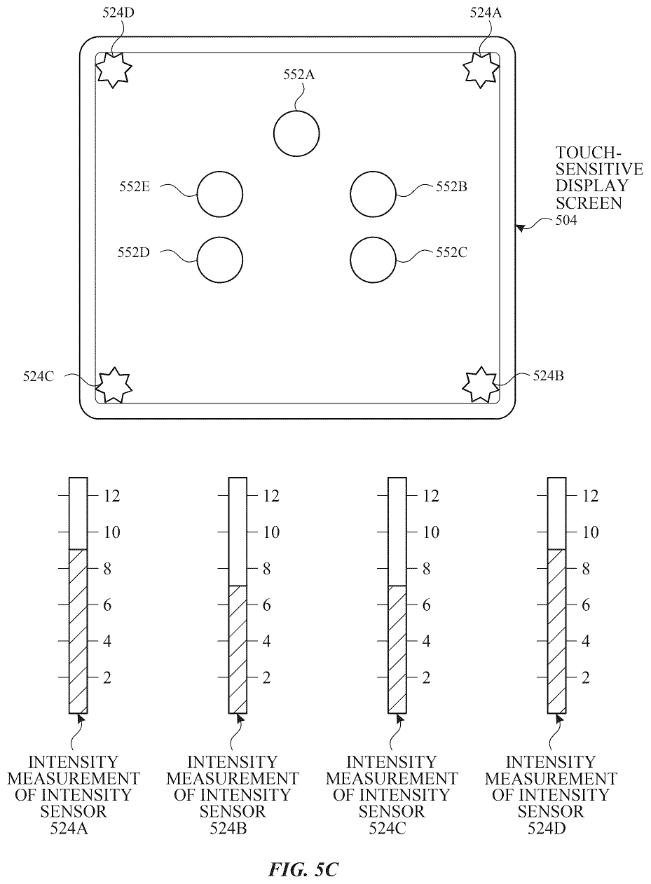

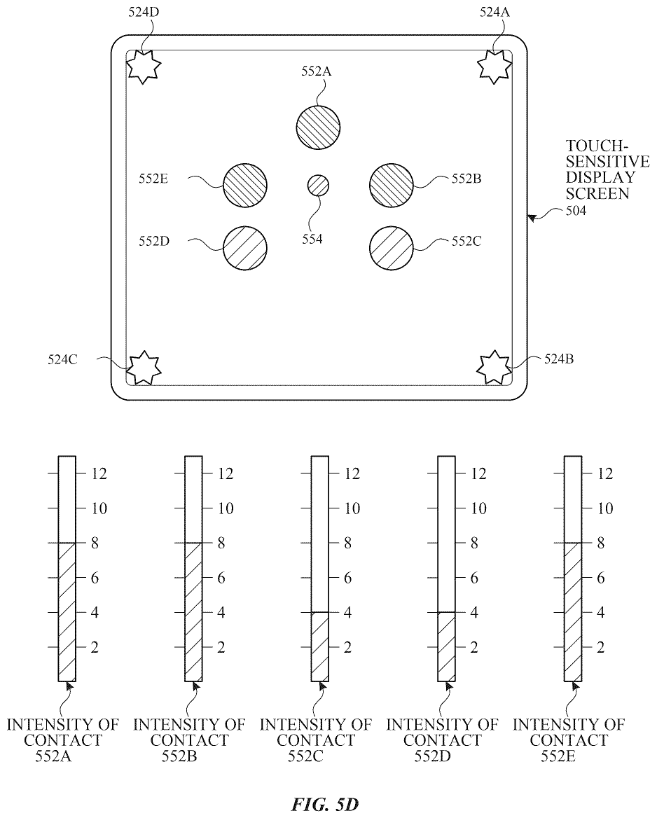

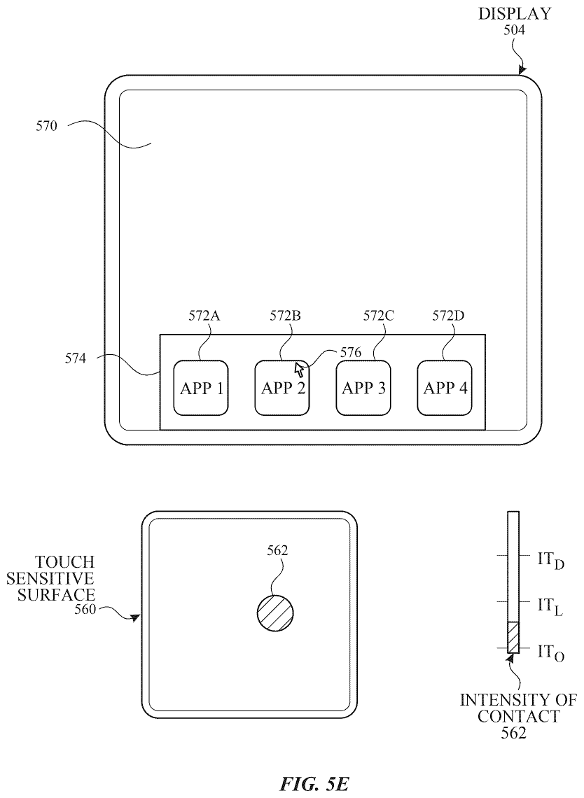

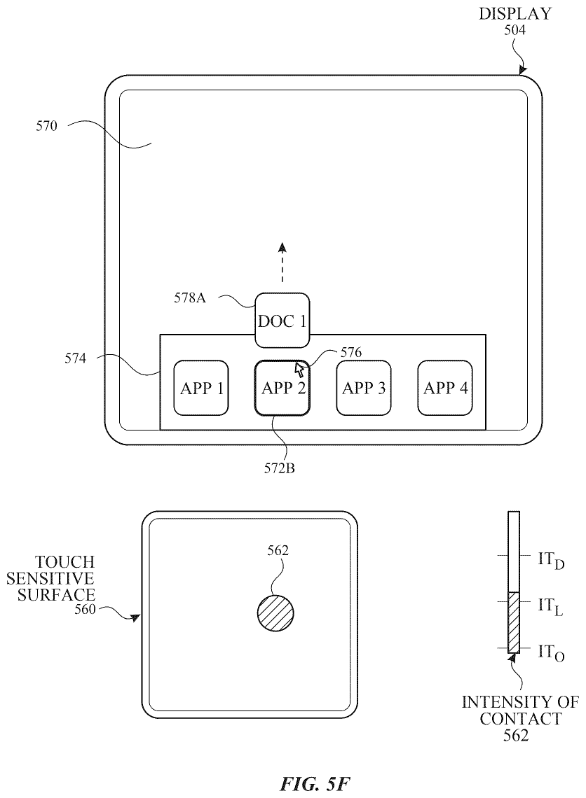

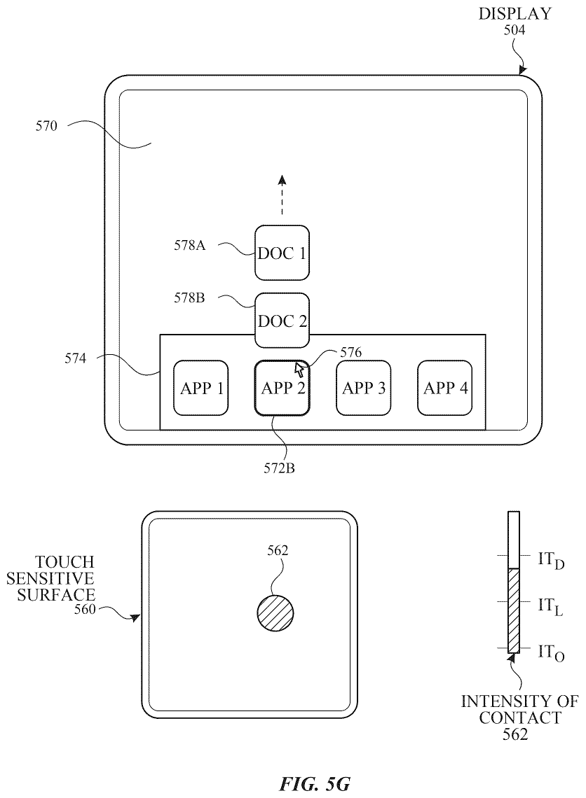

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., methods 700, 900, and/or 1000). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

Users interact with electronic devices in many different manners. In some embodiments, an electronic device is in communication with one or more input devices, a display generation component, and wireless circuitry. In some embodiments, the electronic device presents a user interface for navigating on a predefined route. In some embodiments, the electronic device provides one or more additional routes when the electronic device detects that the current location of the electronic device is off route from the predefined route. Automatically providing directions to navigate a user that is off route back onto the predefined route provides quick and efficient access to relevant content without the need for additional inputs and thereby reducing erroneous inputs to the electronic device to navigate to a destination location. It is understood that people use devices. When a person uses a device, that person is optionally referred to as a user of the device.

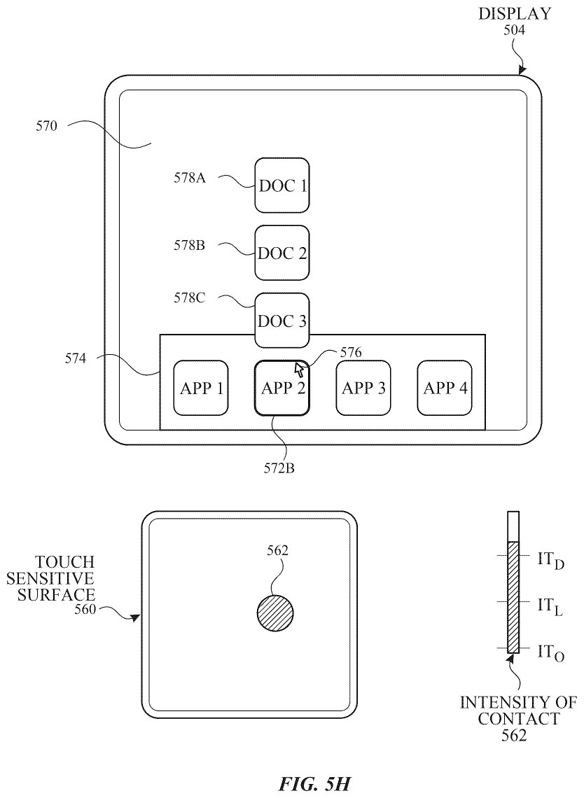

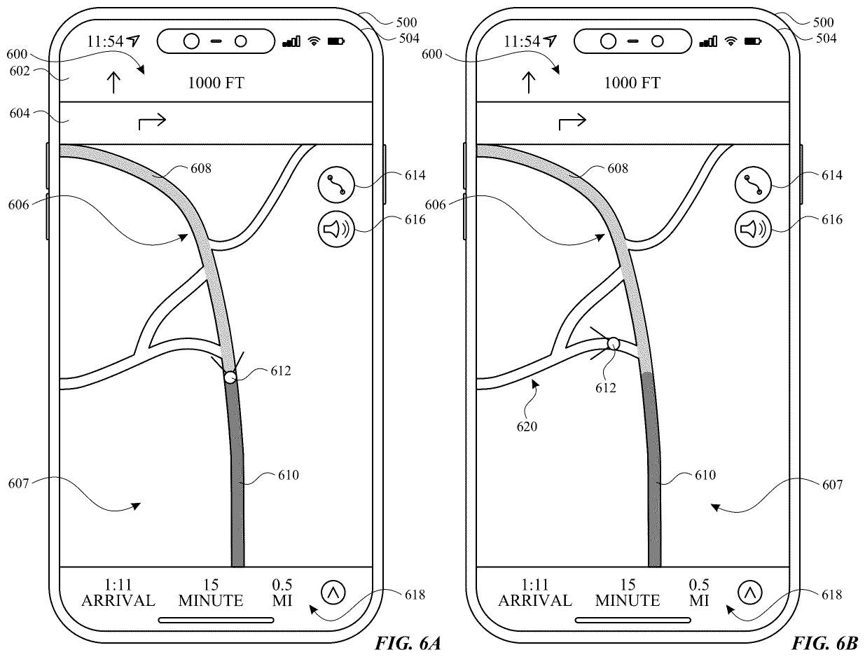

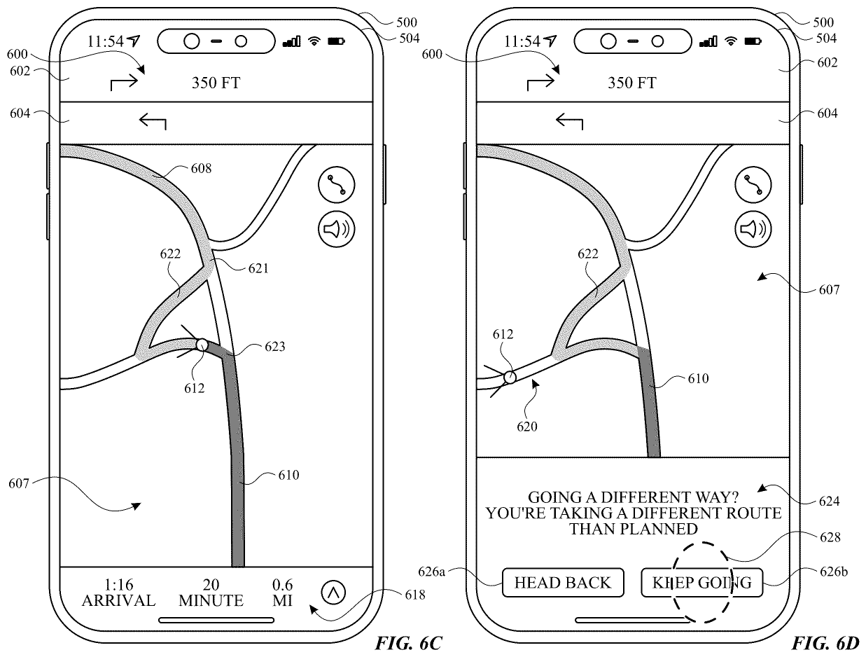

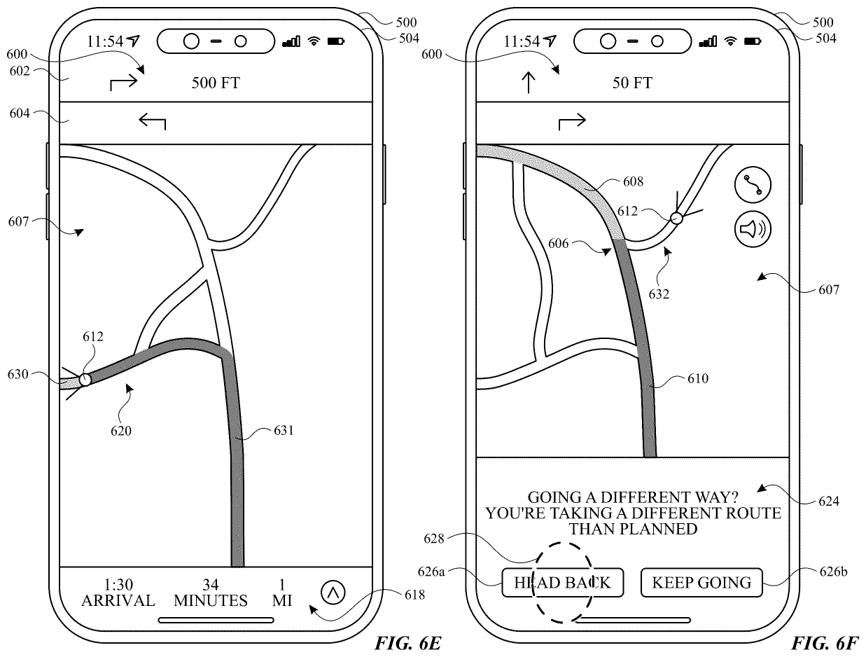

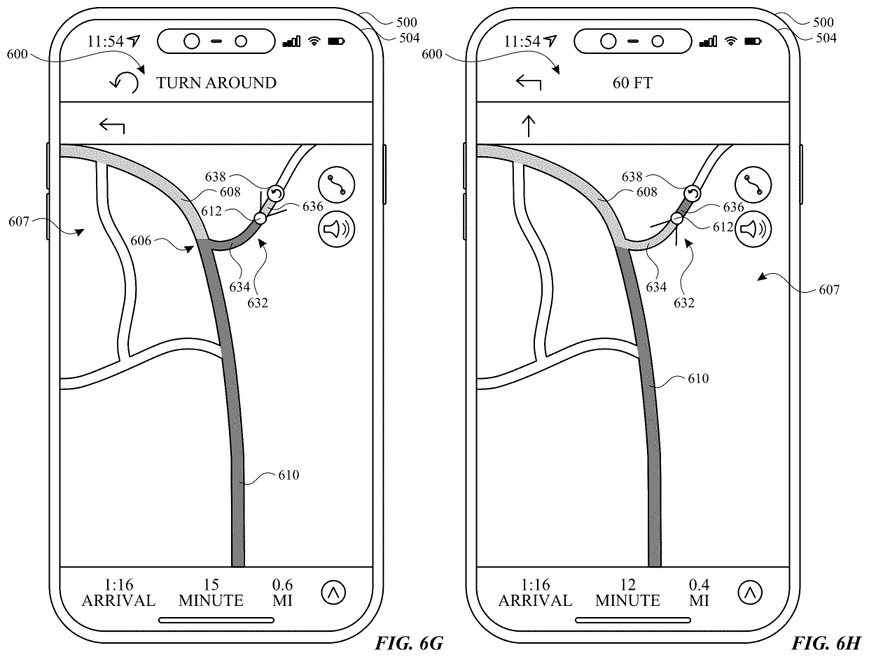

FIGS. 6A-6H illustrate exemplary ways in which an electronic device navigates on a predefined route. The embodiments in these figures are used to illustrate the processes described below, including the processes described with reference to FIG. 7. Although FIGS. 6A-6H illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6H.

FIG. 6A illustrates an electronic device 500 with a display generation component 504 (e.g., a touchscreen). In some embodiments, the electronic device 500 is a mobile device, such as a smartphone, tablet, or wearable device. In FIG. 6A, the electronic device 500 displays user interface 600 corresponding to a navigation user interface of a map application. The electronic device 500 uses user interface 600 to present navigation directions to navigate a respective route. In FIG. 6A, the electronic device 500 presents navigation directions to navigate a predefined route 606 including a first portion 610 and a second portion 608 of the predefined route 606. The user interface 600 includes a region 607 of the user interface where the electronic device 500 displays a representation of map of a physical area including the predefined route 606. In FIG. 6A, the electronic device 500 displays the first portion 610 of the predefined route 606 with a first color to indicate that the electronic device 500 has already traveled that portion of the predefined route, as described in greater detail in method 700. The electronic device 500 displays the second portion 608 of the predefined route 606 with a second color to indicate that the electronic device 500 has not traveled that portion of the predefined route, as described in greater detail in method 700. Indication 612, shown in FIG. 6A, represents the current location of the electronic device 500. Indication 612 also indicates the direction that the electronic device 500 is facing. In FIG. 6A, the electronic device 500 is facing towards the second portion 608 of the route so that the electronic device 500 travels that portion of the predefined route 606.

User interface 600 also includes indications 602, 604, and 618 to provide information relating to the predefined route 606 that the electronic device 500 is currently providing navigational directions for. Indication 602, shown in FIG. 6A, includes text and icons describing the next navigational direction (e.g., continuing straight in 1000 ft). Indication 604 includes text and/or images describing an upcoming navigational direction following the navigational direction described in indication 602. As the electronic device 500 navigates through the predefined route 606, the indications 602 and 604 update to illustrate the present upcoming navigational directions for the predefined route 606. For example, after continuing straight in 1000 ft, the electronic device 500 updates indications 602 and 604 such that the navigational direction previously displayed by indication 604 is now displayed in indication 602 (e.g., the right turn) and a distance is optionally added. The next upcoming navigational direction is then displayed in indication 604. In FIG. 6A, indication 618 includes text and/or images describing the predefined route 606. For example, indication 618 includes text describing the estimated arrival time at the end of the route, the time remaining to finish traveling the predefined route 606, and the distance remaining along the route. Indication 618 also includes a selectable option that, when selected, causes the electronic device 500 to expand the indication 618 to display additional information and/or selectable options relating to the predefined route 606. User interface 600 also includes selectable option 614 and 616, shown in FIG. 6A. Option 614, when selected, causes the electronic device 500 to display an overview of the predefined route 606 (e.g., including additional and/or all portions of the predefined route 606). Option 616, when selected, causes the electronic device 500 to mute or unmute playback of the audio directions for navigating the predefined route 606.

FIG. 6B illustrates the electronic device 500 moving such that the current location of the electronic device 500 is a threshold distance off route from the predefined route 606. In some embodiments, the threshold distance is described in greater detail in method 700. In FIG. 6B, the electronic device 500 updates the location of indication 612 from a first location, shown in FIG. 6A, to a second location, shown in FIG. 6B, which is off route from the predefined route 606. In FIG. 6B, the current location of electronic device 500, represented by indication 612, is on path 620, which is not a path that is part of predefined route 606.

After detecting that the electronic device 500 is off route from the predefined route 606, the electronic device 500 displays a second route including portion 622 from the current location of the electronic device (e.g., the second location of indication 612, shown in FIG. 6B), back to the predefined route 606, shown in FIG. 6C. In some embodiments, the second route including portion 622 directs the electronic device 500 to a location 621 on the predefined route that is less than a threshold distance from a first location 623, where the electronic device 500 deviates from the predefined route 606. Providing navigation directions using a second route is described in greater detail in method 700. In FIG. 6C, the electronic device 500 displays portion 622 with the first color because the electronic device 500 has not traveled that portion of the second route yet. Additionally, in response to displaying the second route including portion 622, the electronic device 500 updates the information presented in indication 618 to reflect the portion 622.

In FIG. 6D, the electronic device 500 detects that the current location of the electronic device 500 is still off route from the second route and the predefined route 606. For example, the electronic device 500 continues to move (e.g., be moved by a user of the electronic device 500) along path 620. In response to detecting that the electronic device 500 is not on the second route or the predefined route 606 and is optionally still moving in a direction not in the direction of the second route or the predefined route 606, the electronic device 500 displays visual indication 624, shown in FIG. 6D. Visual indication 624 includes text describing that the current location of the electronic device 500 is not within the threshold distance of the second route or the predefined route and that the electronic device 500 detects that the current location of the electronic device 500 is moving away from the second route and the predefined route. Visual indication 624 includes options 626a and 626b. In some embodiments, option 626a, when selected, causes the electronic device 500 to display a third route to navigate the electronic device 500 back to the predefined route (e.g., from the current location of the electronic device 500). Option 626b, when selected, causes the electronic device 500 to navigate the electronic device 500 to the end location of the predefined route 606 using the current path that the electronic device 500 is located on (e.g., path 620).

In FIG. 6D, the electronic device 500 receives an input including contact 628 (e.g., a finger, stylus, or an indirect contact such as a mouse clicker) directed towards option 626b. In response to detecting the input including contact 628 in FIG. 6D, the electronic device updates user interface 600 including region 607 to display a third route navigating the electronic device 500 from the current location of the electronic device, represented by indication 612, to the end location of the predefined route 606, shown in FIG. 6E.

FIG. 6E illustrates how the electronic device 500 updates the user interface 600 in response to detecting an input directed towards option 626b, as shown in FIG. 6D. In FIG. 6E, the electronic device 500 displays a first portion 631 of the route that has been traveled with the second color and a second portion 630 of the route that has not been traveled with the first color. In some embodiments, in response to receiving the input in FIG. 6D, the electronic device 500 no longer displays the predefined route 606 and/or the second route including portion 622 in FIG. 6E. Instead, the electronic device 500 displays the third route that includes a portion of the route on the path 620, such that the electronic device 500 is able to continue traveling on the path it is currently located on (e.g., path 620).

FIG. 6F illustrates a different embodiment of region 607 of user interface 600. In FIG. 6F, the current location of the electronic device 500 is off route, similar to the situation described with reference to FIG. 6B. In FIG. 6F, the current location of the electronic device 500 (e.g., represented by indication 612) is on path 632, and not on the predefined route 606. In FIG. 6F, the electronic device 500 receives an input including contact 628 directed towards option 626a. In response to receiving the input, the electronic device 500 updates region 607 to include an updated route, shown in FIG. 6G.

FIG. 6G illustrates an updated route (including portions 634 and 636) including a turnaround point 638 to navigate the electronic device 500 from the current location to a location on the predefined route 606. In some embodiments, turnaround points are described in greater detail in method 700. In FIG. 6G, the electronic device 500 displays navigation directions to navigate the electronic device 500 from the current location to a location on the predefined route 606. Because the current location of the electronic device 500 is on a path 632 that does not reconnect to the predefined route 606 at a location less than a threshold distance from the point that the electronic device 500 deviated from the predefined route 606, the electronic device 500 displays navigational directions that include a turnaround point 638. In FIG. 6G, the portion 610 of the predefined route and the portion 634 of path 632 that has been traveled by the electronic device 500 is displayed with the second color. The portion 636 of the path 632 that has not been traveled by the electronic device 500 (e.g., the portion of the path up to the turnaround point 638 since the electronic device 500 has not reached the turnaround point 638) and the portion 608 of the predefined route 606 is displayed with the first color to indicate that these portions are upcoming in the route as described in greater detail in method 700.

In FIG. 6H, the electronic device 500 has moved locations such that the electronic device 500 has traveled to the turnaround point 638 and then to the current location, represented by indication 612. After turning around, the electronic device 500 updates the characteristics of the route lines such that the portion of the route that has not been traveled (e.g., portion 608 of the predefined route and portion 634 of the path 632) are displayed with the second color, and the portion of the route that has been traveled (e.g., portion 610 of the predefined route and portion 636 of the path 632) are displayed with the first color. In some embodiments, the coloring of path 632 (e.g., portion 634 and 636) is reversed in FIG. 6H as compared to FIG. 6G because after the electronic device 500 is turned around after the turnaround point 638, the previously traveled portion of the path (e.g., portion 634 in FIG. 6G) has to be traveled again in FIG. 6H, therefore the coloring of portion 634 is updated from the first color to the second color.

In some embodiments, the electronic device 500 uses a rerouting algorithm to determine the second route to display after the electronic device 500 detects that the current location of the electronic device 500 is a threshold distance off route from the predefined route (e.g., predefined route 606 shown in FIG. 6A). The rerouting algorithm optionally includes a plurality of steps, and optionally results in generating and/or displaying a new route that routes the user from a current location of the user (e.g., the current location of the electronic device) back onto the predefined route. In some embodiments, the electronic device 101 computes or determines a set of decision points for reconnecting to the predefined route 606 from the current location of the electronic device 101, shown in FIG. 6A. In some embodiments, the decision points are intersections on the second portion 608 of the predefined route 606 (e.g., the unfinished portion of the predefined route, or the portion of the predefined route that has not yet been traversed by the electronic device/user due to the deviation of the electronic device/user from the predefined route) that connect to other paths (e.g., that connect to two or more other paths, such as two or more other roads, trails, and/or other paths), such as path 632, shown in FIG. 6F, and path 620 shown in FIG. 6D. In some embodiments, the decision points also include a start and end point of the second portion 608 of the predefined route 606.

In some embodiments, the electronic device 101 compute an optimal or preferred path (e.g., shortest distance, fastest time, and/or least elevation change) from the current location of the electronic device 101 to one or more or all decision points. In some embodiments, the electronic device 101 computes the optimal or preferred path after computing the set of decision points. In some embodiments, the electronic device 101 uses a one-to many graph search algorithm to compute or determine the optimal or preferred path to the one or more or all of the decision points. The available roads, trails, or other traversable segments for determining the optimal or preferred paths are optionally any roads, trails, or other traversable segments between the current location of the electronic device and the decision points, optionally including roads, trails, or other traversable segments that were or are part of the original predefined route.

In some embodiments, the electronic device 101 filters the set of decision points (and corresponding optimal or preferred paths) to remove the redundant points (and corresponding optimal or preferred paths) from consideration as a candidate route back to the predefined route. In some embodiments, a decision point is redundant if the optimal or preferred path from the current location of the electronic device 101 to the respective decision point uses (or includes) one or more roads, trails, or other traversable segments that are part of the predefined route 606 to reach the respective decision point. In some embodiments, a decision point (and corresponding optimal or preferred path) is redundant or otherwise filtered or removed from consideration if the optimal or preferred path to a respective decision point leads to a local detour. In some embodiments, a local detour occurs when the optimal path includes navigation against the direction of the predefined route 606, and thus requires a U-turn (e.g., using a turnaround point as shown in FIG. 6F) be performed once the current location of the electronic device 101 reaches the respective decision point (e.g., to continue from: 1) the path back to the predefined route, to 2) the predefined route). In some embodiments, a decision point (and corresponding optimal or preferred path) that includes a local detour is only removed as a candidate route back to the predefined route if the local detour has a magnitude (e.g., length, time and/or elevation change) that is greater than a magnitude threshold (e.g., length threshold, time threshold and/or elevation change threshold); otherwise, the decision point (and corresponding optimal or preferred path) is optionally maintained.

In some embodiments, the electronic device 101 determines a rerouting cost for the remainder of the decision points. In some embodiments, the electronic device optionally determines the rerouting cost after filtering the set of decision points, as described above. In some embodiments, the rerouting cost is a cost value assigned to navigating from the current location of the electronic device 101 (e.g., the current location of the electronic device 101 shown in FIG. 6B) to the respective decision point, plus a cost value assigned to the portion of the predefined route 606 that would be or is skipped assuming the predefined route is resumed from the respective decision point (e.g., the cost of navigating from the point that that the electronic device 101 deviates from the predefined route 606 (e.g., first location 623, shown in FIG. 6C) to the location of the respective decision point (e.g., such as second location 621, shown in FIG. 6C), or the cost of navigating from the beginning of the predefined route to the respective decision point). In some embodiments, the cost or cost value for a given route or section of a route is proportional to the length, duration and/or elevation change of the given route or section of the route (e.g., the longer distance, the longer duration and/or the greater elevation change, the higher the cost). In some embodiments, the cost of the skipped portion of the predefined route for a respective decision point is multiplied by a constant in the total cost value determination for that respective decision point, which may be modified based on the threshold route distance, described in greater detail in method 700, and/or which may be modified to weight towards resuming the predefined route earlier in the predefined route (e.g., by increasing the constant) or later in the predefined route (e.g., by decreasing the constant).

In some embodiments, the electronic device 101 selects the optimal or preferred path corresponding to a respective decision point that minimizes the rerouting cost—determined as described above—as the second route to navigate the electronic device 101 back to the predefined route 606. In some embodiments, the optimal path corresponding to a respective decision point that minimizes the rerouting cost optionally still includes a local detour. In such instances, the electronic device 101 may select the first decision point (e.g., the decision points are ranked by lowest cost to highest cost) that minimizes rerouting costs without including a local detour. After determining the second route to navigate the electronic device 101 back to the predefined route 606, the electronic device 101 displays the second route in user interface 600—and when the electronic device 101 reaches the selected decision point, the electronic device 101 optionally displays a resumption of the predefined route from the selected decision point.

In some embodiments, the electronic device 101 uses a number of reroute requests or events that have occurred during the navigation of the predefined route (e.g., how often and/or how many times the current location of the electronic device 101 deviates from the predefined route before navigating along the second route and/or before detecting confirmation of the displayed re-routing indication) to infer user intent and/or to modify the above-described parameters of the re-routing algorithm. For example, as the number of reroute requests or events increases, the electronic device optionally decreases the cost of skipped portion of the predefined route (e.g., increases the constant described above), thus weighting more and more towards skipping more of the predefined route in the re-routing algorithm. As a related example, as shown in FIG. 6D, the electronic device 101 displays visual indication 624 after detecting that the electronic device 500 is not on the second route or the predefined route 606 and is optionally still moving in a direction not in the direction of the second route or the predefined route 606.

FIG. 7 illustrates a flow diagram illustrating a method in which an electronic device navigates on a predefined route according to some embodiments of the disclosure. The method 700 is optionally performed at first electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

Method 700 is performed at an electronic device in communication with one or more input devices and a display generation component, such as electronic device 500, shown in FIG. 6A. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor). In some embodiments, method 700 is performed at or by an automobile (e.g., at an infotainment system of an automobile having or in communication with one or more display generation components and/or input devices).

In some embodiments, while navigating along a first predefined route using a maps application (e.g., the first predefined route is a route from a first location to a destination location. In some embodiments, the first predefined route is a route created using walking as the mode of transportation. Alternatively, in some embodiments, the first predefined route is created using driving or transit as the mode of transportation. In some embodiments, the predefined route is a particular route including predefined paths and/or maneuvers. In some embodiments, the starting location, ending location (destination location), or the path between the starting and ending locations are not based on the current location of the electronic device. In some embodiments, the starting location, ending location, and the path between the starting and ending location are predetermined.), the electronic device receives (702a), via the one or more input devices, an indication that one or more criteria are satisfied, including a first criterion that is satisfied when a current location of the electronic device (and/or a current location of a user of the electronic device) is at least a threshold distance away from the first predefined route, such as indication 612 representing the current location being a threshold distance from route 606 shown in FIG. 6B, and a second criterion that is satisfied when the electronic device is moving towards a second location on the first predefined route that is more than a threshold route distance away (e.g., a distance along the route, or a percentage of the route) from a first location on the first predefined route at which the electronic device deviated from the first predefined route to the current location of the electronic device, such as indication 612 moving towards a location on path 620 shown in FIG. 6B. In some embodiments, the threshold distance is optionally 10 m, 100 m, 500 m, or 1 km away from the first predefined route (e.g., a location on the first predefined route such as the last location of the electronic device on the first predefined route). For example, the user makes a wrong turn, and the electronic device is off-route from the first predefined route. In some embodiments, the one or more criteria also includes a criterion that is satisfied when the electronic device is off-route but traveling towards a different portion of the first predefined route. In some embodiments, the threshold route distance is 10 m, 100 m, 500 m, or 1 km. In some embodiments, the threshold route distance is a percentage (e.g., 5%, 10%, 30%, 50%, 75%, or 90%) of the route. For example, the second location is more than a threshold route distance away from the first location if the distance from the first location to the second location is more than the percentage (e.g., 5%, 10%, 30%, 50%, 75%, or 90%) of the total distance of the first predefined route. In some embodiments, the threshold distance and the threshold route distance are straight-line distances (e.g., as the crow flies), or a distance along the route (e.g., the first predefined route is not a straight line and has curves such as turns, switchbacks, or other turns along the route that adds distance). In some embodiments, the one or more criteria includes a third criterion that is satisfied when the current location of the electronic device is closer in distance (e.g., as the crow flies or distance via known paths) to the second location than the first location. In some embodiments, if the third criterion is not satisfied (e.g., the one or more criteria are not satisfied), then the electronic device provides navigation directions from the current location of the electronic device to the first location without additional prompts or inputs.

In some embodiments, in response to receiving the indication, the electronic device displays (702b), via the display generation component, a selectable option to navigate to the first predefined route from the current location of the electronic device (e.g., a selectable option to go back to the first predefined route from the current location), such as option 626a, shown in FIG. 6D. In some embodiments, the electronic device displays the selectable option overlaid over the navigation along the first predefined route. In some embodiments, the selectable option includes a visual indication indicating that the current location of the electronic device is off route from the first predefined route. In some embodiments, the electronic device also displays a second selectable option that when selected, ends the navigation along the first predefined route. For example, the user has gone off-route and wants to keep going off-route, described in greater detail below.

In some embodiments, the electronic device receives (702c), via the one or more input devices, an input selecting the selectable option, such as input including contact 628 shown in FIG. 6F. In some embodiments, the input is a selection input, such as a tap, an air gesture, a gaze, and/or a click using a mouse/trackpad directed towards the selectable option and/or a voice input requesting to navigate to the first predefined route.

In some embodiments, in response to receiving the input (702d), the electronic device presents (702e) navigation directions from the current location of the electronic device to a respective location on the first predefined route that is less than the threshold route distance away from the first location, such as the route including portions 634 and 636, shown in FIG. 6G. In some embodiments, the electronic device presents directions using the same mode of transportation as used to generate the first predefined route. In some embodiments, the respective location on the first predefined route is the last location of the electronic device that was on the first predefined route (e.g., the first location). For example, the user makes a right turn instead of continuing straight at a fork and the path to bring the user back to a respective location (e.g., the second location) on the first predefined route that is less than a threshold route distance from the first location is turning around and walking back towards the fork (e.g., the last location on the first predefined route). In some embodiments, the respective location on the first predefined route is not the last location on the first predefined route. For example, the user makes a right turn on to a second path instead of continuing straight at a fork and the shortest path back to the first predefined route is to continue on the second path until a second right turn, which returns to the first predefined route at a second location on the predefined route that is within the threshold route distance from the first location. In some embodiments, the electronic device suggests alternate paths to return to the first predefined route (e.g., a shortcut) when the alternate paths are present.

Automatically providing directions to navigate a user that is off route back onto the first predefined route provides quick and efficient access to relevant content without the need for additional inputs and thereby reducing erroneous inputs to the electronic device to navigate to a destination location.

In some embodiments, presenting navigation directions from the current location of the electronic device to the respective location on the first predefined route includes navigating (e.g., displaying navigation instructions and/or outputting audio of navigation instructions) using a second route from the current location of the electronic device to a third location (e.g., the respective location on the first predefined route that is less than the threshold distance away from the first location) on the first predefined route, such as the route including portions 634 and 636, shown in FIG. 6G. In some embodiments, the second route is not a predetermined route. For example, the electronic device determines/creates the second route in response to detecting that current location of the electronic device is at least a threshold distance away from the first predefined route and that the electronic device is moving towards the second location that is more than a threshold route distance away from the first location of the first predefined route. In some embodiments, the third location on the first predefined route is less than a threshold route distance away from the first location. In some embodiments, the second route is a route including a turnaround point such that the electronic device is directed back to the first location (e.g., the first location is the third location). Automatically providing a route from the current location off route from the first predefined route to a location on the first predefined route that is within the threshold distance of the first location reduces the number of inputs needed to reroute back to the first predefined route, thereby reducing erroneous inputs to the electronic device.

In some embodiments, navigating along the first predefined route further includes while the current location of the electronic device is within the threshold distance of the first predefined route, displaying, via the display generation component, a route line of the first predefined route (e.g., the route line is overlaid over a map of a physical region including the first predefined route) including a first portion of the route line previously traveled by the electronic device (e.g., the user has already traveled through this section) with a first value for a visual characteristic (e.g., the first portion of the route line is displayed with a first color, a first line width, a first line texture, and/or a first style) and a second portion of the route line not traveled by the electronic device (e.g., the portion of the route that the electronic device is currently navigating and will be navigating) with a second value for the visual characteristic (e.g., the second portion of the route line is displayed with a second color, a second line width, a second line texture, and/or a second style), such as portion 610 of the route displayed with the first color and portion 608 of the route displayed with the second color, shown in FIG. 6A. In some embodiments, the first portion of the route line starts at the location of the start of the first predefined route and ends at the current location of the electronic device, or the last location of the electronic device on the first predefined route. In some embodiments, the second portion of the route line starts at the current location of the electronic device, or the last location of the electronic device on the first predefined route and ends at the location of the end of the first predefined route.

In some embodiments, in response to receiving the indication (e.g., the indication that the one or more criteria are satisfied, described above), in response to receiving the input (e.g., the input selecting the selectable option, described above), and while the electronic device is at the third location on the predefined route (e.g., the location shown by indication 612 in FIG. 6C), the electronic device displays, via the display generation component, a route line corresponding to the first predefined route from the first location on the predefined route to the third location on the first predefined route with the second value for the visual characteristic, such as if the route including portion 608 and the portion between the first location 623 and location 621 were in the second color, shown in FIG. 6C. In some embodiments, and as described above, the electronic device displays the portion of the route line of the first predefined route that was previously traveled by the electronic device with the first value for the visual characteristic. In some embodiments, the electronic device displays the route line from the first location to the third location on the predefined route with the second value even though the electronic device traveled to the third location via the second route and not the first predefined route.

In some embodiments, in response to receiving the indication, in response to receiving the input, and while the electronic device is at the third location on the predefined route, the electronic device displays a route line corresponding to the second route from the first location on the first predefined route to the third location on the first predefined route with the second value for the visual characteristic, such as the route including portion 622 being shown in the second color in FIG. 6C. In some embodiments, after receiving the input that causes the electronic device to present navigation directions from the current location of the electronic device to the third location (e.g., the respective location on the first predefined route that is less than the threshold route distance away from the first location), the electronic device travels along the second route. In some embodiments, the electronic device displays the route line of the second route from the first location to the third location with the second value for the visual characteristic because the electronic device traveled along that route line. Alternatively, in some embodiments, the electronic device only displays the route line of the route traveled (e.g., the second route and not the first predefined route) with the second visual characteristic. Displaying the portion of the route line of the first predefined route as consumed (e.g., the visual characteristics when the portion of the route has been traveled by the electronic device) up to the point of second route meeting up with the first predefined route allows the user to better visualize the portions of the route that would have been traveled if the user did not go off route, thereby enhancing user interactions with the electronic device.

In some embodiments, while navigating along the first predefined route using the maps application, in accordance with a determination that the one or more criteria are not satisfied (e.g., the current location of the electronic device is not at least the threshold distance away from the first predefined route and/or the electronic device is not moving towards the second location on the first predefined route that is more than a threshold route distance away from the first location), the electronic device forgoes displaying the selectable option to navigate to the first predefined route from the current location of the electronic device, such as if the electronic device 500 continues to display the route including portions 610 and 608 in FIG. 6A. In some embodiments, the electronic device provides navigation instructions along the first predefined route, without changes. In some embodiments, if the first criterion is satisfied but the second and third criterion are not satisfied, then the electronic device provides navigation directions from the current location of the electronic device back to the first location on the first predefined route (e.g., the electronic device reroutes the use back to the first predefined route), without needing to receive additional inputs. Continuing to provide navigation directions of the first predefined route if the electronic device is still on the first predefined route reduces erroneous inputs to the electronic device.

In some embodiments, presenting navigation directions from the current location of the electronic device to the respective location (e.g., the location at which the electronic device left the route, as shown by the location at which the color changes from the first color to the second color in FIG. 6F) on the first predefined route includes in accordance with a determination that the electronic device used a first path to travel to the current location of the electronic device (e.g., the electronic device travels off-route to the current location of the electronic device using the first path), the electronic device navigates to the first location on the predefined route including navigating the first path (for example, in reverse), such as path 632 shown in FIG. 6G. In some embodiments, the respective location on the first predefined route that is less than the threshold route distance away from the first location is the first location. For example, the electronic device is on the first path which does not return back to the first predefined route. In some embodiments, presenting navigation directions includes presenting directions to turn around and follow the same route (e.g., the first path) that was previously taken to travel to the current location of the electronic device.

In some embodiments, in accordance with a determination that the electronic device used a second path different from a first path to travel to the current location of the electronic device, navigating to the first location in the predefined route including navigating the second path (for example, in reverse), such as path 632 shown in FIG. 6G. In some embodiments, the second path has one or more characteristics of the first path. In some embodiments, navigating back to the first predefined route while the current location of the electronic device is on the second path includes navigating along the second path in a second direction (e.g., opposite of the direction taken to travel to the current location of the electronic device). Providing navigation directions that include going back the same way that the electronic device traveled to the current location reduces navigational errors thereby reducing computational power of the electronic device.

In some embodiments, the first predefined route includes a first portion of the route starting at a third location and ending at a fourth location in a first direction, such as portion 634 shown in FIG. 6G and a second portion of the route, wherein the second portion of the route is the first portion of the route in a second direction starting at the fourth location and ending at the third location, such as portion 634 shown in FIG. 6H. In some embodiments, the first predefined route includes a portion that includes traveling the same route in opposite directions (e.g., in the first direction and then in the second direction). For example, the first predefined route includes an out and back section. In some embodiments, the first direction and the second direction are opposite directions (e.g., north and south, east and west, or northeast and southeast). In some embodiments, the first predefined route includes a turnaround moment (e.g., at the fourth location), where the electronic device switches direction of travel from the first direction to the second direction. Including a turnaround movement when the route includes an out and back portion allows the user to easily identify an out and back portion, thereby reducing navigation errors and reducing computational power of the electronic device.

In some embodiments, while navigating along the first predefined route using the maps application, in accordance with a determination that the electronic device is moving in a first direction and the current location of the electronic device is a fifth location on the first portion of the route, the electronic device displays, via the display generation component, a route line from the third location to the fifth location on the route with a first value for a visual characteristic (e.g., the first value for the visual characteristic has one or more characteristics of the first value for the visual characteristic as described above) and displaying a route line from the fifth location to the fourth location with a second value for the visual characteristic different from the first value (e.g., the second value for the visual characteristic has one or more characteristics of the second value for the visual characteristic as described above), such as portion 634 having the first color and portion 636 having the second color in FIG. 6G. In some embodiments, displaying the route line from the third location to the fifth location on the route with the first value for the visual characteristic indicates that the route line from the third location to the fifth location is the portion of the route that the electronic device has already traveled. In some embodiments, displaying the route line from the fifth location to the fourth location with the second value for the visual characteristic indicates that the route line from the fifth location to the fourth location is the portion of the route that the electronic device has not traveled yet.

In some embodiments, in accordance with a determination that the electronic device is moving in a second direction, different than the first direction, and the current location of the electronic device is the fifth location on the second portion of the route, the electronic device displays the portion of the route line from the fourth location to the fifth location with the second value for the visual characteristic and displaying the portion of the route line from the fifth location to the third location with the first value for the visual characteristic, such as portion 634 having the second color and portion 636 having the first color in FIG. 6H. In some embodiments, after the electronic device travels from the fifth location to the fourth location and back to the fifth location (e.g., the user with the electronic device reached the turnaround point and turned around), the electronic device updates the visual characteristic such that the route line from the fourth location to the fifth location is displayed with the second value for the visual characteristic (e.g., the portion of the route that has been traveled), and the route line form the fifth location to the third location is displayed with the first value for the visual characteristic (e.g., the portion of the route that has not yet been traveled). In some embodiments, the electronic device displayed the portion of the route line from the fifth location to the location of the end of the route with the first value for the visual characteristic. Displaying portions of the route that have been traveled by the electronic device using a “consumed” style prior to the turnaround point and then displaying the same portions of the route using an “active” style after the turnaround point (because the electronic device is now displaying the second portion of the route) allows the user to easily identify portions of the route that have not been traveled (using the “active style”) thereby reducing navigational errors and therefore reducing the amount of computational power needed by the electronic device.

In some embodiments, the first value for the visual characteristic includes a first visual emphasis less than a second visual emphasis of the second value for the visual characteristic, such as the second color having less of a visual emphasis than the first color, shown in FIG. 6A. In some embodiments, the portion of the route line that has been traveled is displayed with less visual emphasis (e.g., a lighter color, less opacity, thinner lines, and/or dotted lines) than the portion of the route line that has not been traveled, or vise vera. In some embodiments, the second visual emphasis includes darker colors (e.g., dark blue as compared to light blue), a higher opacity, thicker lines, and/or solid lines. Using different styles to indicate portions of the route that have been traveled and that have not been traveled allows the user to easily identify the route thereby reducing erroneous errors to the electronic device.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900, and 1000) are also applicable in an analogous manner to method 700 described above with respect to FIG. 7. For example, the operation of navigating on a predefined route described above with reference to method 700 optionally has one or more of the characteristics of providing navigation directions based on the current location of the electronic device to the start of a predefined route and generating a predefined route described herein with reference to other methods described herein (e.g., methods 900, and 1000). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, receiving operation 702a, 702c, 702d, and displaying operation 702b are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices, a display generation component, and wireless circuitry. In some embodiments, the electronic device presents a user interface for creating a predefined route. In some embodiments, the electronic device presents a user interface for navigating to a predefined route. In some embodiments, while creating the predefined route, the electronic device adds waypoints to create the route on a representation of a map of a physical area differently at a first zoom level than at a second zoom level. Adding waypoints to a known path at a first zoom level and at the location of the input at the second zoom level provides a quick and efficient way to create a predefined route, thereby reducing erroneous inputs to the electronic device. Automatically providing directions to navigate a user to a predefined route if the current location of the electronic device is outside a threshold distance provides quick and efficient access to relevant content without the need for additional inputs and thereby reducing erroneous inputs to the electronic device to navigate to a predefined route. It is understood that people use devices. When a person uses a device, that person is optionally referred to as a user of the device.

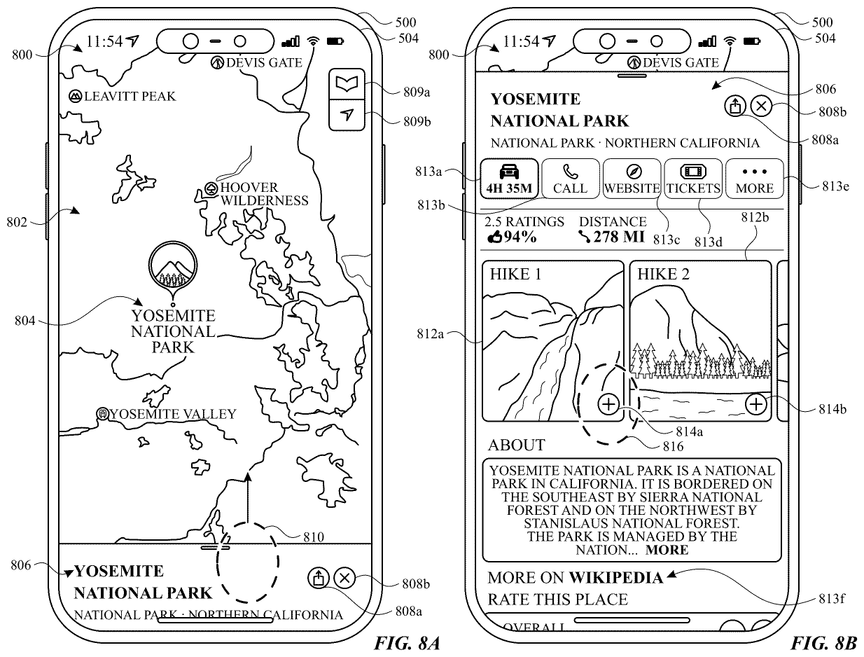

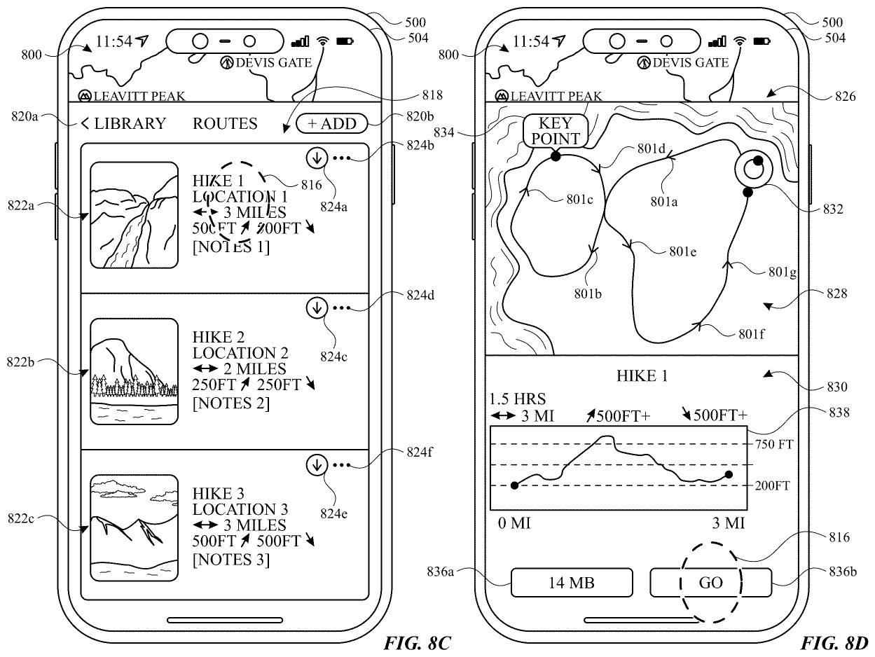

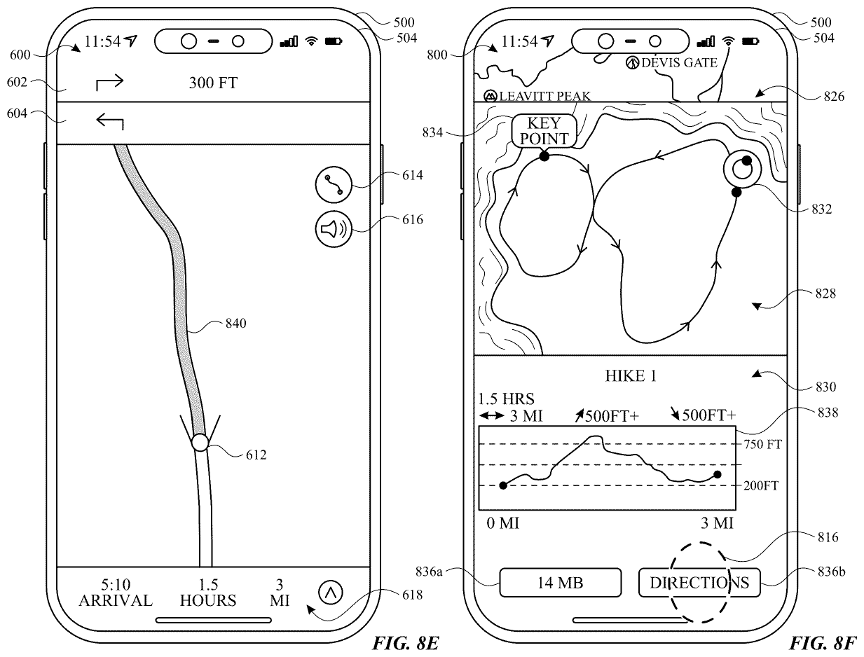

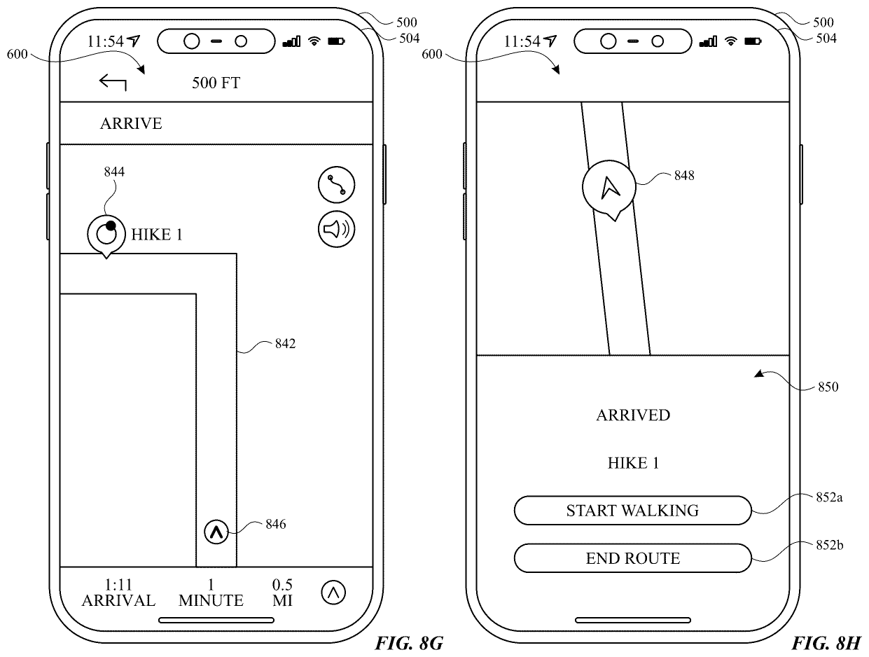

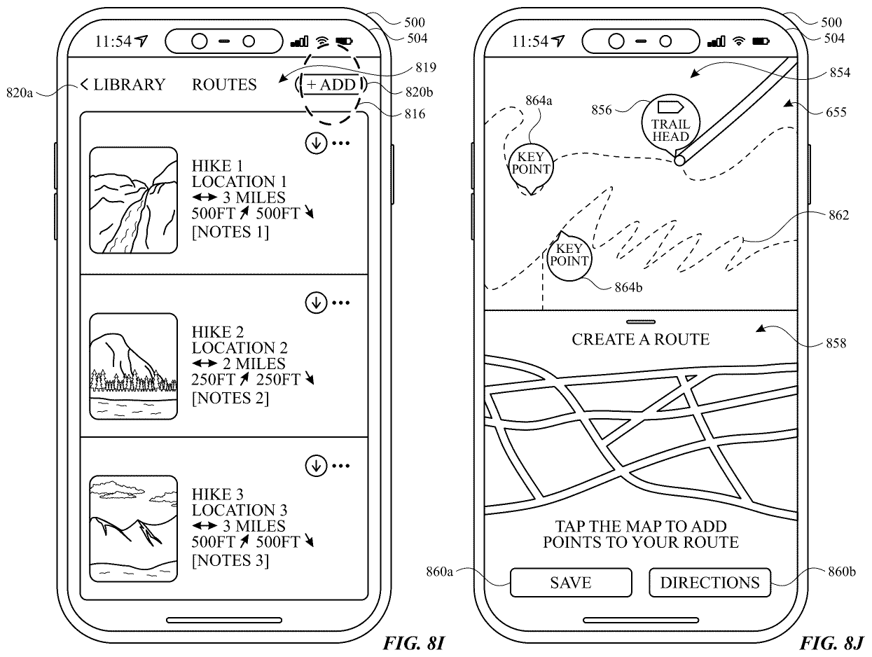

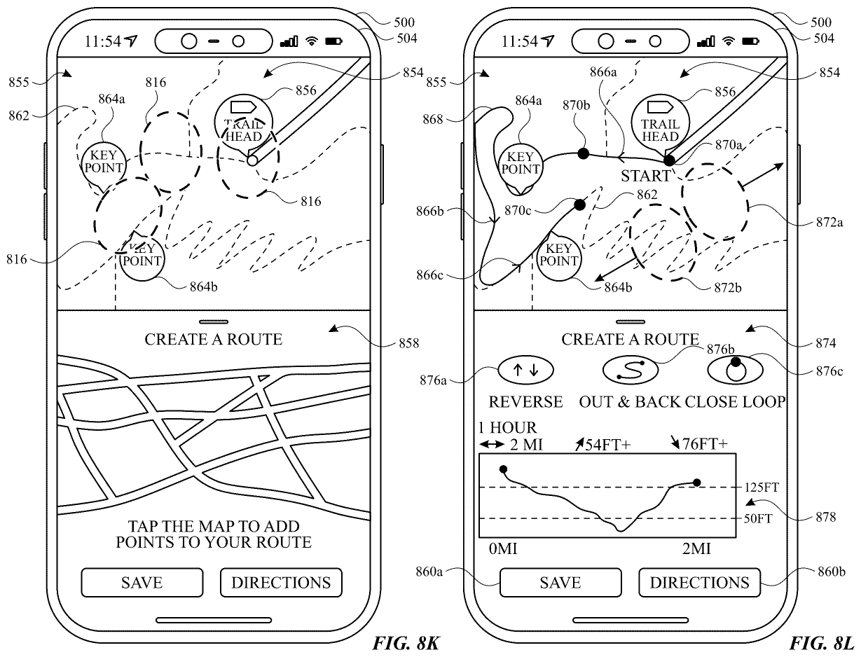

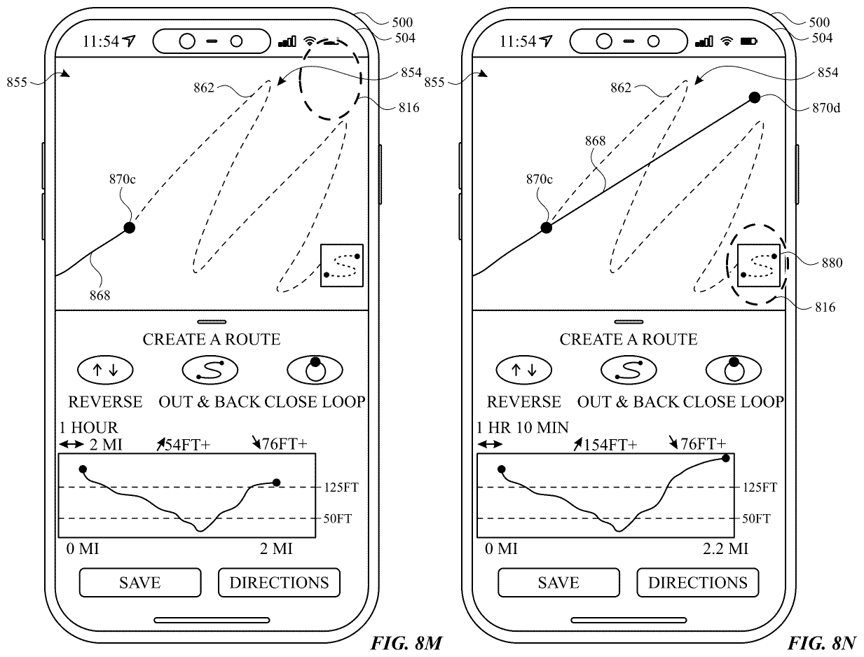

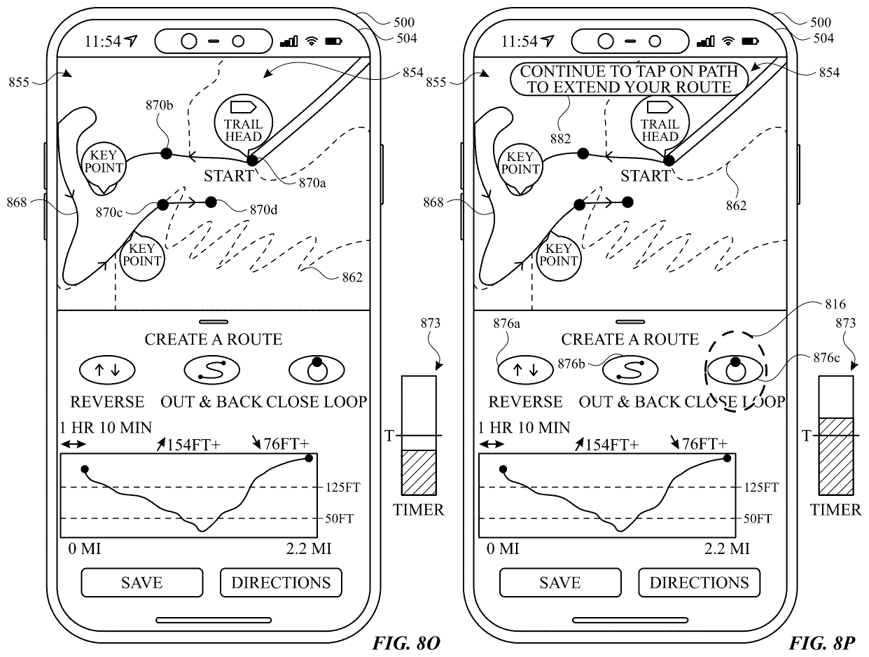

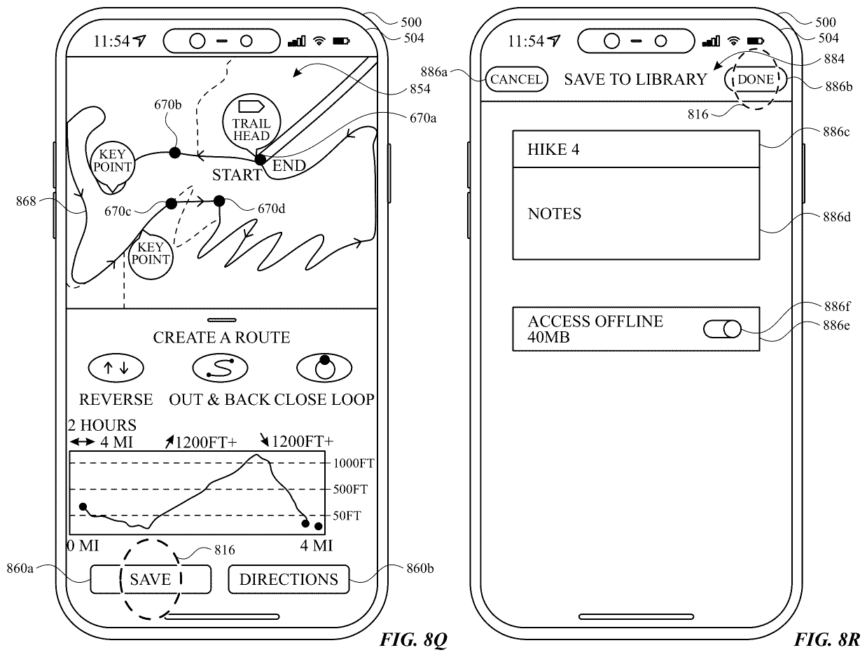

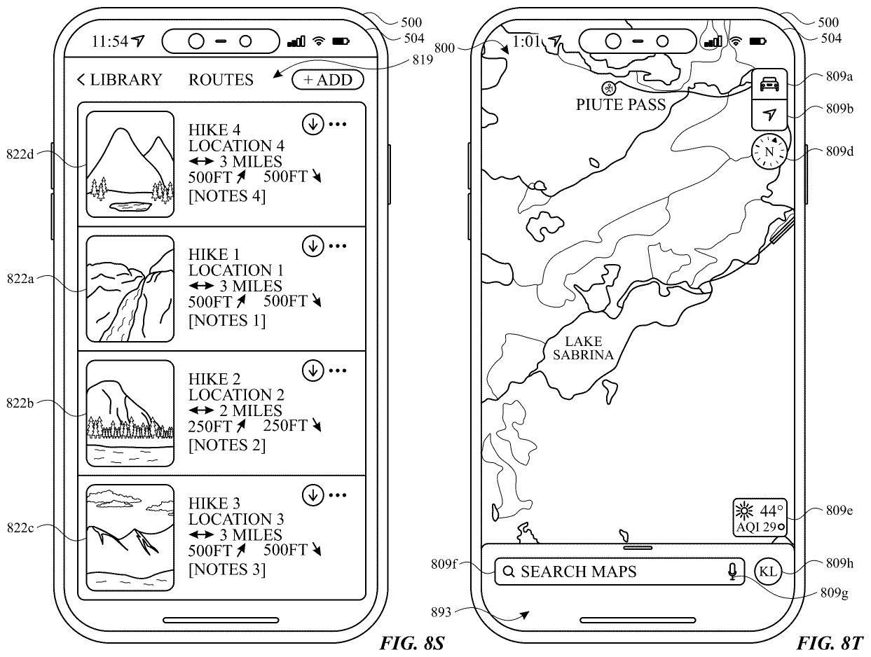

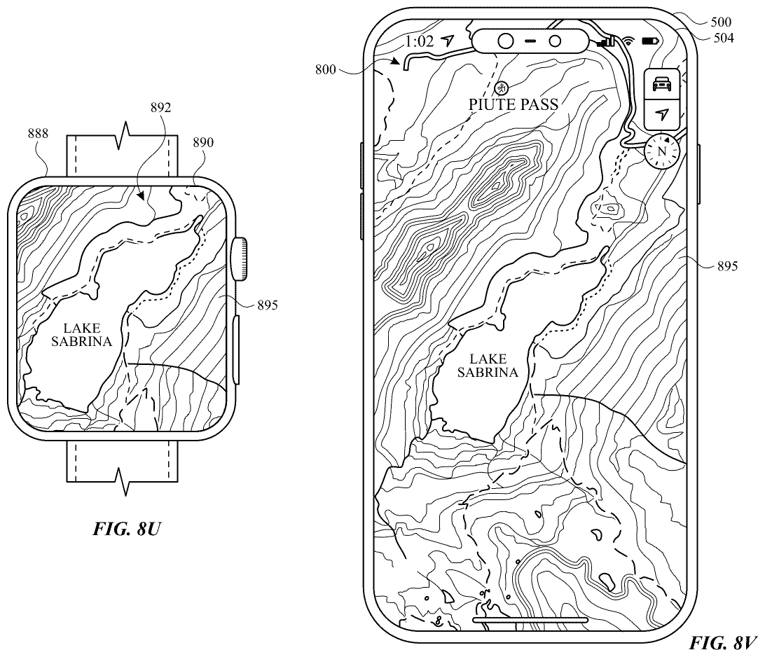

FIGS. 8A-8V illustrate exemplary ways in which an electronic device creates and navigates to a predefined route. The embodiments in these figures are used to illustrate the processes described below, including the processes described with reference to FIG. 9 and FIG. 10. Although FIGS. 8A-8V illustrate various examples of ways an electronic device is able to perform the processes described below with respect to FIG. 9 and FIG. 10, it should be understood that these examples are not meant to be limiting, and the electronic device is able to perform one or more processes described below with reference to FIG. 9 and FIG. 10 in ways not expressly described with reference to FIGS. 8A-8V.

FIG. 8A illustrates an electronic device 500 with a display generation component 504 (e.g., a touchscreen). In some embodiments, the electronic device 500 is a mobile device, such as a smartphone, tablet, or wearable device. The electronic device 500 shown in FIG. 8A optionally corresponds to the electronic device 500 shown in FIG. 6A. In FIG. 8A, the electronic device 500 displays user interface 800 corresponding to a map user interface of a map application. In FIG. 8A, user interface 800 includes a representation 802 of a map of a physical area, which is described in greater detail in method 1000. User interface 800 includes selectable options 809a and 809b. In some embodiments, option 809a, when selected, causes the electronic device 500 to display a plurality of selectable options that, when selected, change a mode of the user interface 800 (e.g., changes the presentation of the representation 802), such as described in method 1000. For example, the plurality of selectable options includes an option that when selected, displays a topographical map of representation 802. The plurality of selectable options also optionally includes an option, that when selected, causes the electronic device to display a transit map of representation 802, including transit lines. In some embodiments, option 809b, when selected, causes the electronic device 500 to orient representation 802 of the map of the physical area such that the top of the representation 802 of the map corresponds to the direction that the electronic device 500 is facing. For example, in FIG. 8A, the electronic device 500 presently displays the representation 802 such that north is the top of the map. In response to receiving an input directed towards option 809b, if the electronic device 500 is pointed west, then the representation 802 would change such that west is at the top of the map, for example.

In FIG. 8A, the representation 802 of a map of the physical area includes a known area such as a national park (e.g., “Yosemite National Park”) shown by indication 804. Because the representation 802 includes a known area and the electronic device 500 previously received a selection input directed towards indication 804, the electronic device 500 displays a user interface element 806 including additional information about the known area. In FIG. 8A, the electronic device 500 displays a portion of the user interface element 806, which includes text describing the known area. The user interface element 806 also includes options 808a and 808b. Option 808a, when selected, causes the electronic device 500 to display one or more selectable options to share the information in the user interface element 806 with another user account optionally using an application other than the application that includes the map. Option 808b, when selected, causes the electronic device 500 to cease displaying the user interface element 806.

In FIG. 8A, the electronic device 500 receives a swipe input including contact 810 (e.g., a direct input using a finger and/or stylus, or an indirect input using a gaze, a cursor, and/or a voice input) directed towards the user interface element 806. In response to receiving the input in FIG. 8A, the electronic device 500 displays a larger portion of user interface element 806 in FIG. 8B (e.g., the electronic device 500 expands the display of the user interface element 806).

FIG. 8B illustrates the user interface element 806 overlaid over user interface 800. In some embodiments, user interface element 806 is scrollable. In some embodiments, in response to detecting a scroll input directed towards element 806, the electronic device 500 displays additional information and/or selectable options relating to the known area. In some embodiments, the user interface element 806 has one or more selectable options 813a through 813f, that when selected, causes the electronic device 500 to navigate to various user interfaces of the map application and/or of different applications. For example, option 813a, when selected, causes the electronic device 500 to display a navigation user interface of the maps application including navigation directions from the current location of the electronic device 500 to a location of the known area (e.g., a location of the visitors center). In some embodiments, the option 813b, when selected, causes the electronic device 500 to navigate to a user interface of a phone application including a number to call relating to the location of the known area. In some embodiments, the option 813c, when selected, causes the electronic device 500 to navigate to a web browser user interface relating to the location of the known area (e.g., a website of the known location such as a visitor information website). In some embodiments, the option 813d, when selected, causes the electronic device 500 to display a web browser user interface to purchase tickets of events relating to the location of the known area. In some embodiments, option 813e, when selected, causes the electronic device 500 to display a menu of selectable options corresponding to the known area (e.g., selectable options to add the known area to a favorites list, downloading the location of the known area, and other options). User interface element 806 also includes information corresponding to known routes (e.g., predefined routes including curated routes described in greater detail in method 900) located within the known area. For example, the known area includes known hiking routes. In FIG. 8B, the known routes are represented by representations 812a and 812b which include corresponding options 814a and 814b, respectively. Representations 812a and 812b include respective text and/or images corresponding to the known routes (e.g., “hike 1” and “hike 2”). In some embodiments, the representations 812a and 812b, when selected, cause the electronic device 500 to display additional information about the respective known route, such as information shown in FIG. 8D. Representations 812a and 812b include options 814a and 814b, which when selected, cause the electronic device 500 to save the respective known route to a library of known routes, as described in greater detail in method 900.

In FIG. 8B, the electronic device 500 receives a selection input including contact 816 directed towards option 814a. In response to receiving the input in FIG. 8B, the electronic device 500 adds the first known route (e.g., “Hike 1”) represented by representation 812a to a library of known hikes, shown in FIG. 8C.

FIG. 8C illustrates a library user interface element 818 overlaid over user interface 800. In some embodiments, the library user interface element 818 and/or other user interface elements described herein (e.g., element 806) are displayed as user interfaces that occupy the full real estate of display 504. For example, the user interfaces are optionally overlaid over user interface 800 or displayed in place of user interface 800. In FIG. 8C, the library user interface element 818 includes selectable options 820a and 820b. Option 820a, when selected, causes the electronic device 500 to display a different user interface of element 818 including a plurality of representations of different collections of predefined routes. Option 820b, when selected, causes the electronic device 500 to display a route creation user interface, described below, to create a predefined route. In FIG. 8C, the user interface element 818 includes a plurality of indications 822a through 822c of saved predefined routes. The indications 822a through 822c include one or more images and/or text corresponding to the respective predefined route. For example, the indications 822a through 822c include respective descriptions of the respective predefined route including the name, location, milage, elevation gain, elevation loss, and notes of the respective predefined route. The indications 822a through 822c also include respective selectable options 824a through 824e. Indication 822a includes options 824a and 824b. In some embodiments, option 824a indicates that the electronic device 500 has downloaded the data relating to the predefined route of indication 822a, which is described in greater detail in method 900. In some embodiments, option 824a, when selected, causes the electronic device 500 to remove the data relating to the predefined route of indication 822a stored on the electronic device 500 or a storage device in communication with electronic device 500. In some embodiments, option 624b, when selected, causes the electronic device 500 to display a menu of selectable options to perform additional functions relating to the predefined route of indication 822a. Options 624c and 824e have one or more characteristics of option 624a. Options 824d and 824f have one or more characteristics of option 624b.

In FIG. 8C, the electronic device 500 receives a selection input including contact 816, directed towards indication 822a. In response to receiving the input in FIG. 8C, the electronic device 500 displays user interface element 826 including information relating to the predefined route (“Hike 1”), shown in FIG. 8D.

FIG. 8D illustrates user interface element 826. User interface element 826 includes a representation 828 of the predefined route overlaid on a representation of a map of a physical area. The representation 828 also includes indication 834, which indicates a key point along the predefined route. Key points are optionally landmarks, and/or frequently visited locations, as described in greater detail in method 900. In some embodiments, indication 834 optionally includes text and/or images that describe the key point. For example, indication 834 optionally includes an icon illustrating the landmark and/or text describing the landmark. The representation 828 also includes indication 832, which indicates the start and the end of the predefined route. Because the predefined route is a loop, the start and the end location of the predefined route is at the same location. In some embodiments, indication 832 includes text and/or images describing the predefined route and/or the start/end of the predefined route. In FIG. 8D, user interface element 826 includes indication 830, which includes text and/or images describing the details/data relating to the predefined route. For example, indication 830 includes graph 838, which illustrates the elevation profile of the predefined route. Additionally, indication 830 includes text describing the name of the predefined route (e.g., “Hike 1”), elevation data, and data for the estimated time to traverse the route. Indication 830 also includes options 836a and 836b. Option 836a indicates how large the data relating to the predefined route is. In some embodiments, option 836a, when selected, causes the electronic device 500 to display information relating to the download of the predefined route, such as an option to download the route, as described in greater detail in method 900. Option 836b, when selected, causes the electronic device 500 to display navigational data. In some embodiments, such as shown in FIG. 8B, the electronic device 500 is within a threshold distance of the start location of the predefined route, as described in greater detail in method 900. Because the electronic device 500 is within the threshold distance of the start location of the predefined route (e.g., represented by indication 832), the electronic device 500 displays the text “Go” on option 836b, and when selected, the electronic device 500 displays navigational data to navigate along the predefined route using walking directions, as shown in FIG. 8E.

In FIG. 8D, the representation 828 of the predefined route includes arrows 801a through 801g that illustrates the direction of travel for the predefine route. In some embodiments, the electronic device 500 determines the direction of travel based on how the route was created, as described in method 1000 and shown in FIGS. 8J-8Q.

In FIG. 8D, the electronic device 500 receives a selection input, including contact 816, directed towards option 836b. In response to receiving the input in FIG. 8D, the electronic device 500 displays user interface 600, described in greater detail in FIG. 6A and in method 700, including navigational directions for the predefined route, in FIG. 8E.

FIG. 8E illustrates user interface 600 including walking directions for the predefined route. FIG. 8E includes indications 602 and 604 which indicate upcoming directions for the predefined route, as described in greater detail in FIG. 6A. In FIG. 8E, the electronic device 500 displays an indication 612 of the current location of electronic device 500 included in the representation of the map including a portion 840 of the predefined route. As described with reference to FIG. 6A, the portion 840 of the predefined route is shown with the first color to indicate that the electronic device 500 has not traveled that portion of the predefined route.

FIG. 8F illustrates a different embodiment of user interface element 826. In some embodiments, such as shown in FIG. 8F, the electronic device 500 is greater than a threshold distance away from the starting location of the predefined route. Because of that, the electronic device 500 displays option 836b. In FIG. 8F, option 836b includes text, “directions” instead of “go” as shown in FIG. 8D. In instances where the electronic device 500 is greater than a threshold distance away from the starting location of the predefined route, the option 836b, when selected, causes the electronic device 500 to display navigational directions to navigate to the start of the predefined route (e.g., driving directions to the start of the predefined route).

In FIG. 8F, the electronic device 500 receives a selection input including contact 816 directed towards option 836b. In response to receiving the input in FIG. 8F, the electronic device 500 displays user interface 600, shown in FIG. 8G, including navigational directions to navigate the electronic device 500 to the start of the predefined route.

FIG. 8G illustrates user interface 600 including navigational directions to navigate the electronic device 500 to the start of the predefined route. In some embodiments, the navigational direction are driving directions, or directions for another mode of transportation other than walking. In FIG. 6G, indication 846 represents the current location of the electronic device 500. Indication 844 represents the starting location of the predefined route. Indications 844 and 846 include icons and/or text describing the respective indication. Because the current location of the electronic device 500 is greater than a threshold distance away from the starting location of the predefined route, the electronic device 500 displays indications 844 and 846 separately, as described in greater detail in method 900.

FIG. 8H illustrates user interface 600 when the current location of the electronic device 500 is within a threshold distance of the starting location of the predefined route. For example, the user arrives at the trailhead (e.g., via car or another mode of transportation other than walking). In FIG. 8G, the electronic device 500 ceases displaying both indications 844 and 846. Instead, the electronic device 500 displays indication 848 indicating the current location of the device and the beginning of the predefined route because the current location of the electronic device 500 is within a threshold distance of the starting location of the predefined route. Indication 848 includes one or more characteristics of both indication 844 and 846. For example, indication 848 includes the icon from indication 846 and the shape of the indication from 844. Additionally, in response to detecting that the current location of the electronic device 500 is within a threshold distance of the starting location of the predefined route, the electronic device 500 displays user interface element 850 shown in FIG. 8H. User interface element 850 includes text describing that the current location of the electronic device 500 is within a threshold distance of the starting location of the predefined route (e.g., the user has reached their destination). User interface element 850 also includes options 852a and 852b. Option 852a, when selected, causes the electronic device 500 to display navigational directions (e.g., walking directions) to navigate along the predefined route, such as the navigational directions shown in FIG. 8E. Option 852b, when selected, causes the electronic device 500 to stop displaying navigational directions. In some embodiments, in response to detecting an input directed towards option 852b, the electronic device 500 ceases displaying user interface 600 and begins displaying user interface 800 (e.g., begins displaying a representation of a map of a physical area).

FIG. 8I illustrates user interface 819, corresponding to user interface element 818 illustrated in FIG. 8C. In some embodiments, user interface 819 is displayed in place of user interface 800, instead of being overlaid over user interface 800. In FIG. 8I, the electronic device 500 receives a selection input, including contact 816, directed towards option 820b to create a new predefined route. In response to receiving the input in FIG. 8I, the electronic device 500 displays user interface 854 for creating predefined routes, shown in FIG. 8J.

FIG. 8J illustrates user interface 854. User interface 854 includes a representation 655 of a portion of a map of a physical area. The representation 655 includes one or more portions of known paths such as path 862. For example, the electronic device 500 displays maintained trails (e.g., hiking trails, walking paths, bike paths, or other paths) that are part of the physical area represented by the portion of the map. The electronic device 500 also displays key points that are within the portion of the map of the physical area with indications 864a and 864b. In some embodiments, key points are described in further detail in method 1000 and are shown in greater detail in FIG. 8F. The electronic device 500 also displays an indication 856 of a start of a trailhead (e.g., where a known path begins). In some embodiments, the representation 655 includes one or more trailheads and the electronic device 500 displays the corresponding indication for the respective trailheads. User interface 854 also includes element 858, shown in FIG. 8J. Element 858 includes one or more images and/or text describing the route creation process (e.g., “tap the map to add points to your route”). Element 858 also includes options 860a and 860b. In some embodiments, option 860a, when selected, causes the electronic device 500 to save the created route to the library of predefined routes, shown in FIG. 8I. In some embodiments, option 860b, when selected, causes the electronic device 500 to present directions either to the starting location of the created route (e.g., if the current location of the electronic device 500 is not within the threshold distance of the starting location) or to present directions for the created route.

In FIG. 8K, the electronic device 500 receives a plurality of selection inputs including contacts 816 directed towards respective locations on representation 655. Although FIG. 8K illustrates multiple inputs directed towards path 862 using contact 816, the electronic device 500 optionally receives the inputs directed towards the representation 655 independently or consecutively. In response to receiving the respective inputs in FIG. 8K, the electronic device 500 adds three respective waypoints corresponding to the three inputs to the predefined route 868, shown in FIG. 8L.

FIG. 8L illustrates user interface 854 after the electronic device 500 has received one or more inputs to create a route. In FIG. 8L, the electronic device 500 displays predefined route 868 overlaid over a portion of path 862. In some embodiments, the electronic device 500 creates predefined route by connecting waypoints 870a through 870c to form a route. Additionally, predefined route 868 includes arrows 866a through 866c to indicate directionality of the route 868. In some embodiments, the electronic device 500 determines the direction of the route based on the order in which the electronic device 500 receives the inputs. In FIG. 8K, the electronic device detects the inputs including contact 816 in a counterclockwise direction, therefore the arrows are pointed such that the route 868 has the counterclockwise direction.

In FIGS. 8K and 8L, the representation 855 of the map is at a first zoom level (e.g., the representation of the map is at a first scale such as 1 cm: 500 m), described in greater detail in method 1000. Because the representation 855 of the map is at the first zoom level, the inputs including contact 816 cause the electronic device 500 to add waypoints (e.g., waypoints 870a through 870c) on a known path (e.g., path 862), instead of directly at the location of the input, irrespective of whether or not those locations include known paths, as described in greater detail in method 1000.

In FIG. 8L, the electronic device 500 ceases displaying user interface element 858 and displays user interface element 874 which includes data about the predetermined route (e.g., graph 878 which has one or more characteristics of graph 838 shown in FIG. 8F) and route editing options (e.g., options 876a through 876c). Graph 878 illustrates the elevation profile of the predetermined route. In some embodiments, as additional waypoints and additional portions of the predefined route are added, the graph 878 is updated to include the elevation profile of the additional portions added. In some embodiments, the options 876a through 876c are options to add additional portions of a path to the predefined route. In some embodiments, option 876a, when selected, causes the electronic device to reverse the direction of arrows 866a through 866c, such that a user and/or electronic device 500 would travel the route 868 clockwise. In some embodiments, option 876b, when selected, causes the electronic device 500 to add a second portion to route 868 that is clockwise. For example, a user and/or the electronic device 500 would travel route 868 (e.g., after the selection of option 876b) in the counterclockwise direction to waypoint 870c and then in the clockwise direction back to the starting location of the route 868 (e.g., at waypoint 870a). In some embodiments, option 876c, when selected, causes the electronic device 500 to add a second portion to the route 868 that would make route 868 into a loop, as shown in FIG. 8Q.

In FIG. 8L, the electronic device 500 receives a pinching input including movement of contacts 872a and 872b (e.g., a direct input using fingers on a touch screen, a turn of a hardware device such as a crown, or an indirect input such as an air pinch) directed towards representation 855. In response to receiving the input in FIG. 8L, the electronic device 500 updates the zoom level of representation 855 to a second zoom level, shown in FIG. 8M.

FIG. 8M illustrates user interface 854 including representation 855 at a second zoom level (e.g., the representation of the map is at a second scale such as 1 cm: 100 m), described in greater detail in method 1000. In FIG. 8M, the electronic device 500 receives a selection input including contact 816 directed towards a location on the representation 855. In response to receiving the input in FIG. 8M, the electronic device 500 adds a waypoint 870d to the representation 855 and extends the route 868 to connect the waypoint 870c and waypoint 870d, shown in FIG. 8N. Because the representation 855 is at the second zoom level, the electronic device 500 does not add the waypoint 870d on a known path (e.g., path 862), and instead, adds the waypoint 870d to the location at which the input in FIG. 8M was received. Additionally, the electronic device 500 connects waypoint 870c and 807d using a straight line (e.g., as the crow flies) rather than following a known path, which is described in greater detail in method 1000. While at the second zoom level, the electronic device 500 displays option 880 on user interface 854. Option 880, when selected, causes the electronic device 500 to display representation 855 at a zoom level such that additional portions of the route 868 are displayed (e.g., additional or all portions of the route 868 including all the waypoints is displayed in representation 855).

In FIG. 8N, the electronic device 500 receives a selection input including contact 816 directed towards option 880. In response to receiving the input in FIG. 8N, the electronic device 500 displays the representation 855 at a zoom level such that the electronic device 500 displays additional (e.g., all) portions of the route 868 (e.g., the first zoom level), shown in FIG. 80. In FIG. 80, the electronic device 500 has not received any additional inputs. In FIG. 80, timer 873 indicates the amount of time the electronic device 500 has not detected inputs directed towards user interface 854. In FIG. 80, the amount of time is less than a threshold amount of time (“T”).

In FIG. 8P, the electronic device 500 has not detected an input directed towards user interface 854 in an amount of time greater than the threshold amount of time (“T”). In some embodiments, detecting inputs within a threshold amount of time is described in greater detail in method 1000. In FIG. 8P, the timer 873 indicates that the amount of time is greater than the threshold amount of time (“T”), therefore the electronic device 500 displays indication 882 on user interface 854. Indication 882 includes text describing how to continue adding waypoints to complete a route.

In FIG. 8P, the electronic device 500 receives a selection input including contact 816 directed towards option 876c. In response to receiving the input in FIG. 8P, the electronic device 500 adds a second portion to route 868 such that the route 868 forms a complete loop wherein the starting location of route 868 is the ending location of route 868 and the route 868 is not an out and back route, shown in FIG. 8Q.

FIG. 8Q illustrates route 868 as a loop route. After receiving the input in FIG. 8P, the electronic device 500 adds additional portions of path 862 (and/or portions of other paths) such that route 868 forms a loop. In FIG. 8Q, the electronic device 500 receives an input including contact 816 directed towards option 860a to save the route 868 to the library of predefined routes. In response to receiving the input, the electronic device 500 displays user interface 884, shown in FIG. 8R.

FIG. 8R illustrates user interface 884 for saving a route to the library of predefined routes. User interface 884 includes content entry fields 886c and 886d. In some embodiments, the electronic device 500 receives text and/or images to be added to field 886c as a name for route 868. In some embodiments, the electronic device 500 receives text and/or images to be added to field 886d as additional notes for route 868 (e.g., additional information relevant to route 868). User interface 884 also includes indication 886e including toggle 886f. Indication 886e includes text and/or images that illustrates how much storage is needed to store the data corresponding to route 868 (e.g., route data, notes, data relating to the map of the physical area that the route is located, and other data described in greater detail in method 1000). In some embodiments, the electronic device 500 receives inputs to toggle 886f to store data and remove data relating to the route 868 on the electronic device 500 and/or a storage device in communication with the electronic device 500. User interface 884 also includes options 886a and 886b. Option 886a, when selected, causes the electronic device 500 to cease displaying user interface 884 and display user interface 854. Option 886b, when selected, causes the electronic device 500 to save the route 868 to the library of predefined routes.

In FIG. 8R, the electronic device 500 receives an input including contact 816 directed to option 886b. In response to receiving the input, the electronic device 500 saves the route 868 to the library of predefined routes, shown in FIG. 8S.

FIG. 8S illustrates user interface 819, described in greater detail above. In FIG. 8S, the electronic device 500 displays indication 822d, corresponding to route 868 in the user interface 819 because the route 868 is saved to the library of predefined routes and the data relating to route 868 is downloaded to electronic device 500 and/or a storage device in communication with electronic device 500.

FIG. 8T illustrates an embodiment of user interface 800 including a representation of a physical area. In FIG. 8T, the electronic device 500 displays a car icon on option 809a because the electronic device 500 is displaying user interface 800 in a different mode (e.g., a driving mode rather than an explore mode) than the mode shown by option 809a in FIG. 8A. User interface 800 also includes indication 809d, representing a compass which indicates the direction in which the electronic device 500 is facing. User interface 800 includes indication 809e, which includes text and images describing the weather and air quality of the physical area of the physical area represented by the map. In FIG. 8T, the electronic device 500 displays user interface element 983 including content entry field 809f for presenting a search user interface. User interface element 893 also includes option 809g, that when selected, causes the electronic device 500 to activate a microphone for receiving a voice input for the content entry field 809f. User interface element 893 also includes option 809h, that when selected, causes the electronic device 500 to display a menu including one or more additional selectable options to view favorited locations, guides, offline maps, and other settings.

FIG. 8U illustrates an electronic device 888 with a display generation component 890 (e.g., a touchscreen) having one or more characteristics of electronic device 500 and display generation component 504. In some embodiments, electronic device 888 is a wearable device, such as a smart watch. In FIG. 8U, the electronic device 888 displays a user interface 892 corresponding to user interface 800. User interface 892 is a user interface of a maps application of electronic device 888. User interface 892 includes a representation of a physical area corresponding to the physical area in FIG. 8T. In FIG. 8U, the electronic device 500 displays a topographical map including topographical lines 895 of the physical area (e.g., after receiving an input to display a topographical map). Because the electronic device 888 displays the topographical map on user interface 892 of electronic device 888 and because the electronic device 888 shares a user account with electronic device 500, the electronic device 500 also updates the display of user interface 800 such that user interface 800 includes a topographical map, shown in FIG. 8V.

FIG. 9 illustrates a flow diagram illustrating a method in which an electronic device provides navigation directions based on the current location of the electronic device to the start of a predefined route according to some embodiments of the disclosure. The method 900 is optionally performed at first electronic device and/or electronic devices such as device 100, device 300, or device 500 as described above with reference to FIGS. 1A-1B, 2-3, 4A-4B and 5A-5H. Some operations in method 900 are, optionally combined and/or order of some operations is, optionally, changed.

Method 900 is performed at an electronic device in communication with one or more input devices and a display generation component, such as electronic device 500, shown in FIG. 8A. In some embodiments, the electronic device has one or more characteristics of the electronic device described in method 700. In some embodiments, the display generation component has one or more characteristics of the display generation component described in method 700. In some embodiments, the one or more input devices has one or more characteristics of the one or more input devices described in method 700.

In some embodiments, while displaying a navigation user interface in a maps application and while the maps application is configured to navigate along a first predefined route (e.g., described in greater detail in method 700) starting at a first physical location (e.g., using a first mode of transportation such as walking, driving, biking, or transit), the electronic device detects (902a) an indication of a current location of the electronic device, such as the representation of the predefined route, shown in FIG. 8D. In some embodiments, the user creates the first predefined route or the first predefined route is computer generated. In some embodiments, the predefined route was created by a different user (e.g., a second user, a second electronic device, and/or a second organization that shares routes). In some embodiments, the electronic device stores the hiking route on a storage device in communication with the electronic device. In some embodiments, the first predefined route is a hiking route. In some embodiments, the electronic device receives one or more inputs directed towards creating the first predefined route and navigating using the first predefined route. In some embodiments, creating a predefined route is described in greater detail in method 1000. In some embodiments, the first predefined route (e.g., a predefined starting location of the first predefined route) is within a threshold distance (e.g., as described below) of the current location of the electronic device. In some embodiments, the first predefined route (e.g., the predefined starting location of the first predefined route) is not within a threshold distance (e.g., as described below) of the current location of the electronic device. In some embodiments, the electronic device navigates using the first predefined route after receiving one or more inputs to browse for the first predefined route and one or more inputs corresponding to a request to navigate using the first predefined route. In some embodiments, and as described above, the starting and ending location of the first predefined route are predetermined. In some embodiments, the electronic device is able to navigate along the first predefined route even if the current location of the electronic device is not near (e.g., not within the threshold distance of the first physical location, as described below) the starting location of the first predefined roue.

In some embodiments, in response to detecting the indication of the current location of the electronic device (902b), in accordance with a determination that the current location of the electronic device is within a threshold distance of the first physical location (e.g., the starting location of the first predefined route), the electronic device displays (902c), via the display generation component, a first option to present directions to navigate along the first predefined route using a first mode of transportation, such as option 836b shown in FIG. 8D. In some embodiments, the first mode of transportation is the same mode of transportation used to navigate along the first predefined route. For example, if the electronic device is within the threshold distance of the first physical location, the electronic device provides walking directions to navigate along the first predefined route. In some embodiments, the threshold distance is 5 m, 10 m, 50 m, 100 m, or 500 m from the current location to the first physical location. In some embodiments, if the current location of the electronic device is within the threshold distance of the first physical location then the user does not need additional instructions to navigate to the first physical location. In some embodiments, in response to receiving an input directed towards the first option, the electronic device initiates the navigation along the first predefined route using the navigation user interface. In some embodiments, displaying the first option includes not displaying the second option, described below.

In some embodiments, in accordance with a determination that the current location of the electronic device is not within the threshold distance of the first physical location, the electronic device displays (902d) a second option to present directions to navigate from the current location of the electronic device to the first physical location using a second mode of transportation, different from the first mode of transportation, such as option 836b shown in FIG. 8F. For example, if the current location of the electronic device is not within the threshold distance of the first physical location, the electronic device provides driving instructions to navigate from the current location to the first physical location. In some embodiments, the second mode of transportation is one of walking, biking, driving, or transit that is different than the first mode of transportation. In some embodiments, the user optionally chooses to navigate to the first physical location using the first mode of transportation. In some embodiments, displaying the second option includes not displaying the first option.

In some embodiments, while displaying the second option to display directions to navigate from the current location of the electronic device to the first physical location using the second mode of transportation, the electronic device receives (902e), via the one or more input devices, a first input directed towards the second option, such as an input including contact 816 shown in FIG. 8F. In some embodiments, the first input is a selection input, such as a tap, a gaze, and/or a click using a mouse/trackpad directed towards the selectable option.

In response to receiving the first input (902f), the electronic device presents (902g) navigation directions from the current location of the electronic device to the first physical location using the second mode of transportation, such as shown in user interface 600 in FIGS. 8G and 8H. In some embodiments, the electronic device presents navigation directions using the navigation user interface. In some embodiments, once the current location of the electronic device is within the threshold distance of the first physical location, the electronic device presents navigation directions to navigate along the first predefined route. Automatically providing directions to navigate a user to a predefined route if the current location of the electronic device is outside a threshold distance provides quick and efficient access to relevant content without the need for additional inputs and thereby reducing erroneous inputs to the electronic device to navigate to a predefined route.

In some embodiments, while presenting navigation directions from the current location of the electronic device to the first physical location using the second mode of transportation, the electronic device detects that the current location of the electronic device is within the threshold distance of the first physical location, such as the indications 844 and 846, shown in FIG. 8G, combining into indication 848, shown in FIG. 8H. In some embodiments, the threshold distance is described in greater detail above. In some embodiments, the first physical location is the start of the first predefined route, as described above. In some embodiments, the electronic device uses one or more input devices (e.g., a GPS) to detect that the electronic device is within the threshold distance of the first physical location.

In some embodiments, in response to detecting that the current location of the electronic device is within the threshold distance of the first physical location, the electronic device displays, via the display generation component, a third option to present navigation directions to navigate along the first predefined route using the first mode of transportation and a fourth option to cease presenting navigation directions, such as option 852a, shown in FIG. 8H. In some embodiments, while detecting that the electronic device is within the threshold distance of the first physical location (or detecting that the electronic device is at the first physical location), the electronic device ceases presenting navigation directions from the current location of the electronic device to the first physical location. In some embodiments, the third option, when selected, causes the electronic device to present navigation directions along the first predefined route using the first mode of transportation as described above. In some embodiments, the navigation directions using the first mode of transportation is the same navigation directions presented if the electronic device presented the first option, described above. Automatically providing an option to provide directions to navigate a user on a predefined route if the current location of the electronic device is within a threshold distance provides quick and efficient access to relevant content without the need for additional inputs and thereby reducing erroneous inputs to the electronic device to navigation on a predefined route.

In some embodiments, while displaying the navigation user interface in the maps application, the electronic device receives, via the one or more input devices, a second input corresponding to a request to display a library user interface (optionally of the maps application) including a plurality of indications of a plurality of predefined routes, such as if the electronic device 500 receives an input in FIG. 8B to display user interface element 818, shown in FIG. 8C. In some embodiments, the plurality of predefined routes includes user created routes, as described in method 1000, and/or computer generated routes that have been saved to the library user interface. For example, a user saves one or more predefined routes and the electronic device displays indications of the saved routes in the library user interface. In some embodiments, the second input is a selection input, as described above, directed towards an option that, when selected, causes the electronic device to display the library user interface.

In some embodiments, in response to receiving the second input, the electronic device displays, via the display generation component, the library user interface (optionally of the maps application) including the plurality of indications of the plurality of predefined routes including a first indication of the first predefined route and a second indication of a second predefined route, such as user interface element 818 shown in FIG. 8C including indications 822a through 822c corresponding to respective predefined routes. In some embodiments, the indications, as described below, include data pertaining to the respective predefined route. In some embodiments, the indication includes a preview of the respective predefined route (e.g., a representation of the route line of the respective predefined route). Route lines are described in greater detail with reference to method 700. Displaying a collection of saved predefined routes in one location allows the user to quickly view relevant routes, thereby reducing erroneous errors to the electronic device.

In some embodiments, the first indication of the first predefined route includes a first name, a first location, first hiking data, and first notes corresponding to the first predefined route, such as indication 822a shown in FIG. 8C, and the second indication of the second predefined route includes a second name, a second location, second hiking data, and second notes corresponding to the second predefined route, such as indication 822b shown in FIG. 8C. In some embodiments, the name of the respective route is user created or computer generated. In some embodiments, location of the respective route includes a description of the region that the respective predefined route is located. In some embodiments, hiking data includes data pertaining to elevation gain and loss, distance, estimated time to complete, and/or maximum elevation of the respective predefined route. In some embodiments, notes include user inputted notes. In some embodiments, the first indication of the first predefined route includes a selectable option to navigate using the first predefined route and the second indication of the second predefined route includes a selectable option to navigate using the second predefined route. In some embodiments, in response to receiving an input directed towards a respective selectable option, the electronic device navigates along the respective predefined route in accordance with method 900 (e.g., navigating to the start of the respective predefined route or navigating along the respective predefined route, as described above). Displaying information relevant to the first predefined route in one location allows the user to quickly and efficiently view relevant data, thereby reducing erroneous errors to the electronic device.

In some embodiments, displaying the navigation user interface in the maps application further includes displaying a representation of the first predefined route, such as representation 828 shown in FIG. 8D. In some embodiments, in accordance with a determination that the first predefined route passes through a first point of interest, displaying, via the display generation component, an indication of the first point of interest located on the first predefined route, such as the predefined route passing through a key point represented by indication 834, shown in FIG. 8D In some embodiments, the points of interest are predetermined. For example, they are determined by the electronic device based on frequency of visit, popularity, and/or input by users associated with the respective points of interest. In some embodiments, points of interest include trails, trailheads, landmarks (e.g., canyons, lakes, oceans, arches, national recreation areas, national parks, national landmarks, and/or mountains), frequently visited locations, gas stations, restaurants, grocery stores, and bars. In some embodiments, the indication of the first point of interest includes text and/or images describing the first point of interest.

In some embodiments, in accordance with a determination that the first predefined route does not pass through the first point of interest, forgoing displaying the indication of the first point of interest, such as the electronic device not displaying any other indications of key points in FIG. 8D. In some embodiments, points of interests that are within a threshold distance of the first predefined route are displayed. In some embodiments, the threshold distance is 0.1 m, 5 m, 10 m, 500 m, or 1 km away from the first predefined route. Displaying points of interests relevant to the first predefined route while displaying the representation of the first predefined route allows the user to quickly and efficiently view relevant data, thereby reducing erroneous errors to the electronic device.

In some embodiments, displaying the representation of the first predefined route further includes displaying one or more indications of a direction of travel of the first predefined route (e.g., lines, signs, and/or icons such as arrows overlaid on the representation of the first predefined route to indicate a direction of travel. In some embodiments, the one or more indications of the direction of travel are not based on the detected direction of travel of the electronic device and/or not based on the current location of the electronic device. In some embodiments, the one or more indications of the direction of travel are different and/or separate from an indication of the current location of the electronic device on the route and an indication of the direction that the electronic device is currently facing.), such as arrows 801a through 801g shown in FIG. 8D.

In some embodiments, in accordance with a determination that the first predefined route includes a first portion of a predetermined path in a first direction, displaying the one or more indications of the direction of travel in the first direction such as arrows 801a through 801g shown in FIG. 8D. In some embodiments, the first portion of the predetermined path is able to be traveled in both directions (e.g., the first direction or the second direction or in other directions). For example, travel in both directions is allowed per local laws at the location of the predefined path, such as the predefined path being a two-way road, path, walkway, and/or trail. In some embodiments, the electronic device determines that the first portion of the predetermined path is in the first direction based on the way that the first predefined route is constructed/created, as described in method 1000. In some embodiments, if the first predefined route is constructed such that the electronic device navigates the first portion of the predetermined path in the first direction, then the electronic device displays one or more indications of (e.g., arrows) the first direction of travel on the representation of the first portion of the predetermined path of the first predefined route. In some embodiments, the order of selection of the waypoints (described in method 1000) used to construct the route corresponds to the direction of travel. For example, if the route includes a first waypoint and a second waypoint such that the user selects the first waypoint and then the second waypoint, then the route has a first direction of travel. If the user selects the second waypoint and then the first waypoint, then the route has a second direction of travel.
in accordance with a determination that the first predefined route includes the first portion of the predetermined path in a second direction, displaying the one or more indications of the direction of travel in the second direction, such as arrows 801a through 801g shown in FIG. 8D. In some embodiments, if the first predefined route is constructed such that the electronic device navigates the first portion of the predetermined path in the second direction, then the electronic device displays one or more indications of the second direction of travel on the representation of the first portion of the predetermined path of the first predefined route. In some embodiments, the first predefined route includes traveling on the first portion of the predetermined path in both directions (e.g., an out and back portion of the route), and the electronic device displays the representation of the first portion of the predetermined path of the first predefined route with indications of travel in the first direction and the second direction. Displaying indications of travel on the first predefined route allows the user to quickly and efficiently view relevant information to the first predefined route, thereby reducing erroneous errors to the electronic device.

In some embodiments, presenting navigation directions from the current location of the electronic device to the first physical location using the second mode of transportation further includes generating the navigation directions after receiving the first input, such as the directions shown in user interface 600 shown in FIG. 8G. In some embodiments, the electronic device generates the navigation directions after receiving the first input and the navigation directions were not created by the user of the electronic device prior to receiving the first input. In some embodiments, the navigation directions are based on the detected current location of the electronic device and the navigation directions change based on the current location of the electronic device when the first input is detected.

In some embodiments, presenting directions to navigate along the first predefined route using the first mode of transportation further includes generating the navigation directions before receiving an input directed towards the first option, such as representation 828 of the first predefined route being predefined shown in FIG. 8E. As described in method 1000, a user of the electronic device is able to create one or more predefined routes that includes navigation directions. As described above, the first predefined route is optionally computer generated prior to receiving the input directed towards the first option. Because the first predefined route was created before receiving the input, the navigation directions are also generated before receiving the input. In some embodiments, the navigation directions along the first predefined route are not based on the detected current location of the electronic device. In some embodiments, the navigation directions along the first predefined route do not change based on the current location of the electronic device. Generating the navigation directions using the second mode of transportation after receiving the first input reduce excessive computation needs of the electronic device thereby reducing battery consumption.

In some embodiments, in response to detecting the indication of the current location of the electronic device, in accordance with the determination that the current location of the electronic device is within the threshold distance (e.g., 0.1 m, 5 m, 10 m, or 500 m) of the first physical location, displaying, via the display generation component, an indication of the current location of the electronic device over the first physical location of the first predefined route, such as indication 848 shown in FIG. 8H In some embodiments, the electronic device forgoes displaying the indication of the start of the first predefined route, described below. In some embodiments, the indication of the current location includes text and/or figures/icons illustrating the current location of the electronic device. In some embodiments, the electronic device combines the indication of the start of the first predefined route and the indication of the current location when the electronic device is within the threshold distance of the first physical location.

In some embodiments, in response to detecting the indication of the current location of the electronic device, in accordance with the determination that the current location of the electronic device is not within the threshold distance of the first physical location, displaying, via the display generation component, an indication of the current location of the electronic device and an indication of the start of the first predefined route on the first physical location, such as indication 844 and 846, shown in FIG. 8G. In some embodiments, the indication of the current location of the electronic device is described above. In some embodiments, the indication of the start of the first predefined route includes text and/or figures/icons illustrating the start of the first predefined route. For example, an image/icon illustrating the start of a trail or a trailhead. In some embodiments, if the electronic device detects a movement of the electronic device such that the current location of the electronic device is within the threshold distance of the first physical location, then the electronic device updates the display of the indications to just display the indication of the current location or an indication of a combination of the indication of the current location and the indication of the start of the first predefined route. In some embodiments, if the electronic device is within the threshold distance and the electronic device moves such that the current location is not within the threshold distance, then the electronic device updates the display of the indication of the current location of the electronic device over the first physical location of the first predefined route to include the display of the indication of the current location of the electronic device and the indication of the start of the first predefined route on the first physical location. Combining the indication of the current location and the indication of the start of the first predefined route if the current location of the electronic device is within the threshold distance of the start of the first predefined route reduces clutter on the user interface, thereby reducing errors to the electronic device.

In some embodiments, while displaying the navigation user interface in the maps application, the electronic device receives, via the one or more input devices, a second input corresponding to a request to display respective information on a representation of a map of a physical area, such as an input including contact 810 shown in FIG. 8A. In some embodiments, the second input is a selection input, having one or more characteristics of selection inputs described above, directed towards an option for displaying a plurality of indications of predefined routes. In some embodiments the respective information includes information corresponding to a specific region of the map (e.g., a known region such as a park). For example, the respective information includes information corresponding to predefined routes in the specific region (e.g., the physical area described below), general history and/or information about the physical area, visitor guides, addresses, phone numbers, hours, reviews, and/or other information about the physical area.

In some embodiments, in response to receiving the second input, the electronic device displays a plurality of indications corresponding to predefined routes in the physical area including the first predefined route, such as indications 812a and 812b shown in FIG. 8B. In some embodiments, in response to receiving the second input, the electronic device displays a user interface including a collection of predefined routes relevant to the physical area. For example, the electronic device displays a collection of Yosemite valley hikes if the physical area is Yosemite valley. In some embodiments, the predefined routes are computer generated and/or crowd sourced. For example, the predefined routes include known routes in the physical area. In some embodiments, the predefined routes are created using the one or more predefined paths in the physical area. In some embodiments, the respective indications include respective selectable options to navigate along the respective routes. In some embodiments, in response to receiving an input directed towards a respective selectable option, the electronic device navigates along the respective predefined route in accordance with method 900 (e.g., navigating to the start of the respective predefined route or navigating along the respective predefined route, as described above). Displaying a plurality of indications of predefined routes relevant to the physical area in one place reduces erroneous inputs to the electronic device to find predefined routes, thus reducing power usage.

In some embodiments, while displaying the plurality of indications corresponding to predefined routes in the physical area including the first predefined route, the electronic device receives, via the one or more input devices, a third input corresponding to a request to add the first predefined route to a library of predefined routes (optionally in the maps application), such as input including contact 816 directed towards option 814a, shown in FIG. 8B. In some embodiments, the third input is a selection input having one or more characteristics of the selection inputs described above. In some embodiments, the third input is directed towards an option that when selected, causes the electronic device to add the first predefined route to the library of predefined routes. In some embodiments, the library of predefined routes is described in greater detail above.

In some embodiments, in response to receiving the third input, the electronic device adds the first predefined route to the library of predefined routes, such adding indication 822a to the library shown in FIG. 8C. In some embodiments, the library of predefined routes includes one or more predefined routes of the physical area and of other physical areas. In some embodiments, the library of predefined routes also includes user generated routes. In some embodiments, after adding the first predefined route to the library of predefined routes, the electronic device is able to access the first predefined route through the library of predefined routes and/or through the respective information on the representation of the map of the physical area. Including an option to save a route to the library of predefined routes allows the user to easily and efficiently save routes to the library of predefined routes, thereby reducing erroneous inputs to the electronic device.

In some embodiments, adding the first predefined route to the library of predefined routes includes selecting an option to access the first predefined route while the electronic device does not have a network connection, such as toggle 886f shown in FIG. 8R. In some embodiments, the electronic device receives a selection input directed towards the option. In some embodiments, in response to selecting the option, the electronic device downloads the data related to the first predefined route to the electronic device (e.g., a storage device in communication with the electronic device). In some embodiments, the electronic device downloads the data while accessing the network connection. In some embodiments, the data includes data relating to navigation directions, route lines, map features of the first predefined route and of the surrounding areas (e.g., the physical area), points of interest, and/or images. In some embodiments, the predefined routes in the library of predefined routes are accessible while the electronic device does not have the network connection. In some embodiments, if the electronic device does not receive an input directed towards the option, the electronic device does not download the data relating to the first predefined route. Downloading routes in the library of predefined routes allows the electronic device to access the routes when the electronic device does not have network connection, thereby enhancing user interactions with the electronic device.

In some embodiments, while displaying a map user interface in the maps application, wherein the map user interface includes a representation of a map of a respective region (e.g., the maps user interface is a navigation user interface as described above, or a browsing user interface wherein the electronic device does not provide navigation directions and displays the representation of the map), and displaying the representation of the map of the respective region includes in accordance with a determination that a second electronic device in communication with the electronic device (e.g., electronic device 888 shown in FIG. 8U) is in a mode for displaying a topographic map (e.g., in a maps application on the second electronic device corresponding to the maps application on the electronic device), the electronic device displays the representation of the map of the respective region as a topographic map of the respective region, such as shown in FIG. 8V. In some embodiments, the second electronic device is a wearable device (e.g., a smart watch or a headset) or a second electronic device having one or more characteristics of the electronic device. In some embodiments, the second electronic device and the electronic device share a user account. In some embodiments, the second electronic device also includes a corresponding maps application. In some embodiments, while displaying a user interface of the maps application, the second electronic device receives a request to display the topographic map. In some embodiments, in response to displaying the topographic map, the second electronic device transmits an indication to the electronic device that the second electronic device is displaying the topographic map.

In some embodiments, in accordance with a determination that the second electronic device in communication with the electronic device is not in the mode for displaying a topographic map (e.g., in the maps application on the second electronic device corresponding to the maps application on the electronic device), the electronic device displays the representation of the map of the respective region as a map of the respective region other than a topographic map of the respective region, such as user interface 800 shown in FIG. 8T. In some embodiments, the second electronic device is optionally in a different map mode, such as a mode wherein the second electronic device displays transit lines, traffic data, and/or driving data. In some embodiments, the electronic device displays the representation of the map of the respective region using the respective mode that the second electronic device is displaying the representation of the map in. In some embodiments, if the electronic device changes the mode for displaying a map, then the second electronic device also changes the mode that for displaying the map.

Displaying the topographic map on the electronic device if the user displays the topographic map on the second electronic device reduces the number of inputs needed to display the topographic map, thereby reducing erroneous inputs to the electronic device.

It should be understood that the particular order in which the operations in FIG. 9 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and 1000) are also applicable in an analogous manner to method 900 described above with respect to FIG. 9. For example, the operation of providing navigation directions based on the current location of the electronic device to the start of a predefined route described above with reference to method 900 optionally has one or more of the characteristics of navigating on a predefined route and generating a predefined route described herein with reference to other methods described herein (e.g., methods 700 and 1000). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, detecting operation 902a, displaying operation 902c, 902d, receiving operation 902e, and presenting operation 902f are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

FIG. 10 illustrates a flow diagram illustrating a method in which an electronic device displays presents graphs of mathematical equations in accordance with some embodiments of the disclosure. The method 1000 is optionally performed at first electronic device and/or electronic devices such as device 100, device 300, or device 500 as described above with reference to FIGS. 1A-1B, 2-3, 4A-4B and 5A-5H. Some operations in method 1100 are, optionally combined and/or order of some operations is, optionally, changed.

The method 1000 is performed at an electronic device in communication with one or more input devices and a display generation component, such as electronic device 500 shown in FIG. 8A. In some embodiments, the electronic device has one or more characteristics of the electronic device described in method 700. In some embodiments, the display generation component has one or more characteristics of the display generation component described in method 700. In some embodiments, the one or more input devices has one or more characteristics of the one or more input devices described in method 700.

In some embodiments, the electronic device displays (1002a), via the display generation component, a user interface of a maps application for creating predefined routes (e.g., such as the first predefined route, described in greater detail in methods 700 and 900), the user interface including a representation of a map of a physical area, such as user interface 854 including representation 655 shown in FIG. 8J. In some embodiments, the representation of the map of the physical area is a map of a hiking area, a park, or an area of a city. In some embodiments, the map of the physical area is a map of the physical environment of the electronic device, including the current location of the electronic device. In some embodiments, the representation of the map of the physical area is a map of a physical area that does not include the current location of the electronic device, such as a physical area selected by the user. In some embodiments, the representation of the map of the physical area includes indications of roads, buildings, landmarks, natural features such as mountains, bodies of water, and canyons. In some embodiments, if the map is of a physical location that includes the current location of the electronic device, the map includes an indication of the current location of the electronic device.

In some embodiments, while displaying the user interface of the maps application including the representation of the map of the physical area (1002b), the electronic device receives (1002c), via the one or more input devices, an input corresponding to a request to add a waypoint to a route on the representation of the map of the physical area, such as inputs including contacts 816 shown in FIG. 8K. In some embodiments, the input includes a selection input, such as a tap with a contact (e.g., a finger, or stylus), selection with an indirect input device (e.g., mouse, remote control, or trackpad) that is directed to a location of a focus indicator such as a cursor or selection ring) and/or a gaze input (optionally as part of an air gesture). In some embodiments, the input is a tap and hold input such that the user selects a location on the map of the physical area and remains selecting the location for a threshold amount of time (e.g., 0.5 seconds, 1 second, 5 seconds, or 10 seconds). For example, the electronic device receives a tap with a contact for the threshold amount of time. In some embodiments, the input is directed towards a location on the representation of the map at which to add the waypoint.

In some embodiments, in response to receiving the input (1002d), in accordance with a determination that the representation of the map of the physical area is at a first zoom level, the electronic device adds (1002e) the waypoint (e.g., a point used to create a route; a path between at least two waypoints would form a predefined route) to the route at a location of a known path (e.g., a road, fire road, and/or trail already displayed on the map of the physical area) included in the representation of the map of the physical area (e.g., the electronic device “snaps” the waypoint to a known path), such as shown by route 868 shown in FIG. 8L. In some embodiments, the first zoom level is a lower zoom level than the second zoom level, such that at the first zoom level, the electronic device displays more of the map of the physical area than at the second zoom level. For example, the first zoom level is includes displaying the map of the physical area at a 1 cm to 1 km, 500 m, or 200 m scale. For example, at the first zoom level, the electronic device displays a representation of a portion of the map of the physical area corresponding 100 sq km, 50 sq km, 10 sq km, or 5 sq km. In some embodiments, in response to receiving the input at the first zoom level, the electronic device adds the waypoint to the map of the physical area on a known path closest to the location of the input. In some embodiments, if the input is at a location that is closer to a first known path, then the electronic device adds the waypoint on a location on the first known path. In some embodiments, if the input is at a location that is closer to a second known path, different than the first known path, then the electronic device adds the waypoint on a location on the second known path. In some embodiments, the location on the first known path and/or the location on the second known path is a location on the respective known path that is closest to the location of the input. Alternatively, in some embodiments, the location on the first known path and/or the location on the second known path is a predefined location on the respective known path (e.g., beginning, middle, or end of the path). For example, the closest predefined location on the known path to the input is the location of the waypoint. In some embodiments, the location of the waypoint is different than the location of the input on the representation of the map, and the location of the waypoint while the representation of the map is at a second zoom level, described below.

In some embodiments, in accordance with a determination that the representation of the map of the physical area is at a second zoom level, different than the first zoom level, the electronic device adds (1002f) the waypoint to the route at a location corresponding to a location designated with the input (e.g., that is not on a known path and/or independent of whether the location designated with the input is or is not on a known path), such as shown with the addition to route 868 shown in FIG. 8N. In some embodiments, while displaying the representation of the map at the first zoom level or at the second zoom level, the representation of the portion of the map consumes the same display area (e.g., the size of the display). In some embodiments, the second zoom level is a greater zoom level than the first zoom level, such that at the second zoom level, the electronic device displays a smaller area of the map of the physical area. For example, the second zoom level includes display the map of the physical area at a 1 cm to under 200 m scale (e.g., 150 m, 100 m, 50 m, or 25 m). For example, at the second zoom level, the electronic device displays a representation of a portion of the map of the physical area corresponding 4 sq km, 1 sq km, 0.1 sq km, or 0.01 sq km, different from the magnitude of the physical area displayed at the first zoom level. In some embodiments, in response to receiving the input at the second zoom level, the electronic device adds the waypoint to the map of the physical area at the location of the input. In some embodiments, the location of the input is optionally not on a known path (e.g., the user wants to go off trail such as in the backcountry). In some embodiments, the location of the input is on a known path. In some embodiments, the location of the waypoint is different than the location of the waypoint while the electronic device receives an input at the first zoom level. Adding waypoints to a known path at a first zoom level and at the location of the input at the second zoom level provides a quick and efficient way to create a predefined route, thereby reducing erroneous inputs to the electronic device.

In some embodiments, the electronic device receives a sequence of inputs corresponding to requests to add a start point and an end point to create the route, such as inputs including contacts 816 shown in FIG. 8K. In some embodiments, the sequence of inputs includes selection inputs selecting locations on the representation of the map, such as tap inputs (e.g., with a finger, mouse, or stylus, or a gaze input), air gestures and/or hardware input device inputs directed towards areas on the representation of the map of the physical area. For example, the electronic device receives the sequence of inputs directed to different areas of a hiking trail on the representation of the map of the physical area. In some embodiments, the first input corresponds to the starting point and the last input corresponds to the end point. In some embodiments, the starting point and the end point are at the same location on the map (e.g., a loop route or an out and back route). In some embodiments, the electronic device connects the points together to form a route. In some embodiments, the electronic device also receives inputs corresponding to adding one or more waypoints between the start and end point of the route. In some embodiments, if the one or more waypoints (and start and end points) are at a location on a known path (e.g., a hiking trail), then connecting the points together includes using one or more portions of one or more known paths to connect the points. In some embodiments, if one or more points are not at a location of a known path (e.g., off trail), then connecting the points include connecting the points via the shortest distance between the points (e.g., as the crown flies). Creating a route by adding waypoints in response to receiving inputs directed towards locations on the map of the physical area allows the user to easily and efficiently build a route, thereby reducing erroneous inputs to the electronic device.

In some embodiments, the electronic device receives, via the one or more input devices, a second input corresponding to a request to add an end point for the route at the location of a start point of the route, such as receiving an input including contact 816 directed towards option 876c shown in FIG. 8P. In some embodiments, the second input is directed towards a first option that when selected, causes the electronic device to close the route (e.g., making the route a loop route). In some embodiments, the second input is directed towards a second option that when selected, causes the electronic device to make the route an out and back route. In some embodiments, the second input has one or more characteristics of the inputs described above. In some embodiments, the second input is not an input directed towards the location of the starting point of the route (e.g., the second input does not explicitly define or indicate the location of the end point).

In some embodiments, in response to receiving the second input, the electronic device creates the route including the start point and the end point at the first physical location, such as route 868 shown in FIG. 8Q. In some embodiments, creating the route in response to selecting the first option and/or the second option includes extending the route such that the start point and the end point are at the first physical location. For example, in response to selecting the first option, the electronic device extends the route using one or more known paths not already included in the route to return back to the first physical location. For example, in response to selecting the second option, the electronic device extends the route by adding a second portion of the route which uses the same paths as the first portion of the route (e.g. the portion of the route that was previously created prior to receiving the second input) in a reverse direction. Directionality of a route is described in greater detail above. Including options to finish a route by closing the loop or making an out and back loop reduces the number of inputs needed to create a route, thereby reducing erroneous inputs to the electronic device.

In some embodiments, adding the waypoint further includes displaying an indication of information corresponding to the route including the waypoint, such as showing graph 878 and corresponding data in response to adding waypoint 870a through 870c shown in FIG. 8L. In some embodiments, the electronic device displays data relating to the route while the electronic device is receiving inputs to create the route. In some embodiments, as the route is extended, the data relating to the route is updated to reflect the additional portions of the route. In some embodiments, the data relating to the route includes data such as total elevation gain during the route, total elevation loss during the route, distance of the route, an elevation graph of the route, and an estimated time of completion of the route. Displaying relevant data about the route while creating the route reduces the number of inputs needed to view relevant data, thereby reducing erroneous inputs to the electronic device.

In some embodiments, while displaying the indication of information corresponding to the route including the waypoint (e.g., data relating to the route, as described above), the electronic device receives, via the one or more input devices, a second input corresponding to a request to add a second waypoint to the route on the representation of the map of the physical area, such as with input including contact 816 shown in FIG. 8M. In some embodiments, the second input has one or more characteristics of the inputs described above. In some embodiments, the second input is a input directed towards a location on the representation of the map of the physical area, such as a tap input (e.g., with a finger, mouse, or stylus, or a gaze input), air gesture and/or hardware input device input.

In some embodiments, in response to receiving the second input, the electronic device adds the second waypoint to the predetermined route, such as waypoint 870d shown in FIG. 8N. In some embodiments, adding the second waypoint to the predetermined route includes adding an indication of the second waypoint to the representation of the map of the physical area and updating the route (and a representation of the route) to include a path (e.g., via one or more known paths, as described above) between the waypoint and the second waypoint.

In some embodiments, the electronic device updates the information corresponding to the route including the waypoint and the second waypoint, such as updating graph 878 and corresponding data in response to adding waypoint 870d shown in FIG. 8N. In some embodiments, updating the information corresponding to the route includes updating the data relating to the route to include the additional data from the additions to the route, as described above. Updating the relevant data about the route while creating the route reduces the number of inputs needed to view and update relevant data, thereby reducing erroneous inputs to the electronic device.

In some embodiments, while displaying the user interface of the maps application including the representation of the map of the physical area and a representation of the route including the waypoint, in accordance with a determination that a threshold amount of time (e.g., 1 second, 5 seconds, 10 seconds, 30 seconds, 1 minute, 2 minutes, or 5 minutes) has passed since receiving the input (e.g., or any other inputs to generate or create the route), the electronic device displays, via the display generation component, an indication to continue adding waypoints to the route, such as indication 882 shown in FIG. 8P. In some embodiments, the indication is overlaid on the representation the map of the physical area. In some embodiments, the indication includes text and/or images instructing a user to add additional waypoints to the route. In some embodiments, the timer to determine the amount of time that has passed resets after receiving an input. In some embodiments, if the threshold amount of time is reached after a subsequent input, the electronic device displays the indication.

In some embodiments, while displaying the user interface of the maps application including the representation of the map of the physical area and a representation of the route including the waypoint, in accordance with a determination that the threshold amount of time has not passed since receiving the input (and/or since receiving any other inputs to generate or create the route), the electronic device forgoes displaying the indication, such as not showing indication 882 in FIG. 80. In some embodiments, the electronic device receives one or more inputs to add waypoints, a start point, and/or an end point and the threshold amount of time has not passed in between any of the inputs. In some embodiments, after detecting that the route is complete (e.g., there is an endpoint), then the electronic device no longer displays the indication even after the threshold time passes since receiving an input. Automatically displaying the indication to continue adding waypoints allows the electronic device to inform the user on how to create a route, thereby reducing erroneous inputs to the electronic device.

In some embodiments, while displaying the user interface of the maps application including the representation of the map of the physical area and a representation of the route including a start point and an end point, the electronic device receives, via the one or more input devices, a second input corresponding to a request to save the route as a predefined route, such as an input including contact 816 directed towards option 860a shown in FIG. 8Q. In some embodiments, the second input has one or more characteristics of the inputs described above. In some embodiments, the second input is a selection input directed towards an option to save a route.

In some embodiments, in response to receiving the input, the electronic device saves the route as the predefined route in a library (optionally in the maps application) of predefined routes, such as adding indication 882d to the user interface 819 shown in FIG. 8S. In some embodiments saving the route includes downloading the route (e.g., the data relating to the route such as a map of the portion of the physical area including the route, route data (e.g., elevation gain, elevation loss, distance, estimated time of completion), route directions, and/or photos relating to the route) to a storage device in communication with the electronic device, such that the electronic device is able to access the route when not connected to a network. In some embodiments, saving the route includes adding the indication of the route to the library without downloading the route. For example, the electronic device saves a location of where the data relating to the route is located without downloading the data relating to the route. In some embodiments, the library of predefined routes includes one or more routes that were created by the user (or a different user) or created by an electronic device. In some embodiments, the library of predefined routes includes indications of routes. In some embodiments, the indications of routes include respective descriptions including the name of the route, the distance of the route, the elevation of the route, the location of the route, and notes relating to the route. In some embodiments, Displaying a selectable option to save the route while creating the route reduces the number of inputs needed to save the route, thereby reducing erroneous inputs to the electronic device and reduces the number of inputs needed to present a respective route if that route is saved.

In some embodiments, saving the route as the predefined route in the library of predefined routes includes adding a name, notes, and adding the route to a storage device wherein the electronic device accesses the route without network connection, such as shown by content entry fields 886c and 886d and indication 886e shown in FIG. 8R. In some embodiments, saving the route includes displaying a user interface where the user of the electronic device is able to add a name for the route, notes about the route, and other information about the route (e.g., photos and/or videos). In some embodiments, the electronic device receives one or more inputs from a soft keyboard, a physical keyboard, a hardware device, a stylus or finger (e.g., for handwriting), and/or a voice input to add information relating to the route. In some embodiments, saving the route includes adding the data relating to the route, as described above, to a storage device in communication with the electronic device. Including content entry fields to allow a user to add information about a route while saving the route reduces the number of inputs needed to add relevant information, thereby reducing erroneous inputs to the electronic device.

In some embodiments, while displaying the user interface of the maps application including the representation of the map of the physical area and a representation of the route, in accordance with a determination that a current location of the electronic device is within a threshold distance of a starting point of the route (e.g., 10 m, 100 m, 200 m, 300 m, 400 m, 800 m, 1600 m, or 2000 m of the starting point), the electronic device displays a first indication on the representation of the map of the physical area at the current location of the electronic device (e.g., the first indication represents the current location of the electronic device and the starting location of the route and is displayed at the starting location of the route), such as shown by indication 856 in FIG. 8J. In some embodiments, the first indication includes text and or images indicating the current location of the electronic device. In some embodiments, if the electronic device is within the threshold distance of the starting point of the route, then the electronic device displays the first indication to indicate the current location of the electronic device and the starting point of the route. In some embodiments, the first indication has the same image (and/or visual appearance) as the current location indication or the route starting point indication, described below. In some embodiments, the first indication has a different image (and/or visual appearance) than the images of the current location indication or the route starting point indication.

In some embodiments, while displaying the user interface of the maps application including the representation of the map of the physical area and a representation of the route, in accordance with a determination that the current location of the electronic device is not within the threshold distance of the starting point of the route, displaying the first indication on the representation of the map of the physical area at the current location of the electronic device, and a second indication on the representation of the map of the physical area at a location of the starting point of the route, such as if representation 655, shown in FIG. 8J, includes two different indications of location. In some embodiments, if the electronic device is not within the threshold distance of the starting point of the route, the electronic device displays two separate indications indicating the start point of the route and the current location of the electronic device. In some embodiments, the second indication has images and/or text illustrating the starting point of the route. In some embodiments the first indication and the second indication have different visual appearances. Combining the indication of the current location and the indication of the start of the route if the current location of the electronic device is within the threshold distance of the start point of the route reduces clutter on the user interface, thereby reducing erroneous errors to the electronic device.

It should be understood that the particular order in which the operations in FIG. 10 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and 900) are also applicable in an analogous manner to method 700 described above with respect to FIG. 10. For example, the operation of generating a predefined route described above with reference to method 1000 optionally has one or more of the characteristics of navigating on a predefined route, and providing navigation directions based on the current location of the electronic device to the start of a predefined route described herein with reference to other methods described herein (e.g., methods 700 and 900). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 1002a, receiving operation 1002c, adding operation 1002e and 1000f are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data relating to a person's likeness, name, date of birth, or any other identifying or personal information.

The present disclosure recognizes that the use of such personal information data, in the present technology, can be used to the benefit of users. For example, using the electronic device's current location is used to navigate a user along the predefined route. Accordingly, use of such personal information data enables users to use electronic devices to perform enhanced operations with mathematical functions and expressions. Further, other uses for personal information data that benefit the user are also contemplated by the present disclosure. For instance, using a current location allows the electronic device to navigate the user back to the predefined route.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device generated generative visual media content without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with one or more input devices and a display generation component:
while navigating along a first predefined route using a maps application, receiving, via the one or more input devices, an indication that one or more criteria are satisfied, including a first criterion that is satisfied when a current location of the electronic device is at least a threshold distance away from the first predefined route and a second criterion that is satisfied when the electronic device is moving towards a second location on the first predefined route that is more than a threshold route distance away from a first location on the first predefined route at which the electronic device deviated from the first predefined route to the current location of the electronic device;
in response to receiving the indication, displaying, via the display generation component, a selectable option to navigate to the first predefined route from the current location of the electronic device;
receiving, via the one or more input devices, an input selecting the selectable option; and
in response to receiving the input:
presenting navigation directions from the current location of the electronic device to a respective location on the first predefined route that is less than the threshold route distance away from the first location.

2. The method of claim 1, wherein presenting navigation directions from the current location of the electronic device to the respective location on the first predefined route includes navigating using a second route from the current location of the electronic device to a third location on the first predefined route.

3. The method of claim 2, wherein navigating along the first predefined route further includes:
while the current location of the electronic device is within the threshold distance of the first predefined route, displaying, via the display generation component, a route line of the first predefined route including a first portion of the route line previously traveled by the electronic device with a first value for a visual characteristic and a second portion of the route line not traveled by the electronic device with a second value for the visual characteristic; and
in response to receiving the indication:
in response to receiving the input:
while the electronic device is at the third location on the predefined route, displaying, via the display generation component:
a route line corresponding to the first predefined route from the first location on the predefined route to the third location on the first predefined route with the second value for the visual characteristic; and
a route line corresponding to the second route from the first location on the first predefined route to the third location on the first predefined route with the second value for the visual characteristic.

4. The method of claim 1, further comprising:
while navigating along the first predefined route using the maps application, in accordance with a determination that the one or more criteria are not satisfied, forgoing displaying the selectable option to navigate to the first predefined route from the current location of the electronic device.

5. The method of claim 1, wherein presenting navigation directions from the current location of the electronic device to the respective location on the first predefined route includes:
in accordance with a determination that the electronic device used a first path to travel to the current location of the electronic device, navigating to the first location on the predefined route including navigating the first path; and
in accordance with a determination that the electronic device used a second path different from a first path to travel to the current location of the electronic device, navigating to the first location in the predefined route including navigating the second path.

6. The method of claim 1, wherein the first predefined route includes a first portion of the route starting at a third location and ending at a fourth location in a first direction and a second portion of the route, wherein the second portion of the route is the first portion of the route in a second direction starting at the fourth location and ending at the third location.

7. The method of claim 6, wherein while navigating along the first predefined route using the maps application:
in accordance with a determination that the current location of the electronic device is a fifth location on the first portion of the route, displaying, via the display generation component, a route line from the third location to the fifth location on the route with a first value for a visual characteristic and displaying a route line from the fifth location to the fourth location with a second value for the visual characteristic different from the first value; and
in accordance with a determination that the current location of the electronic device is the fifth location on the second portion of the route, displaying the portion of the route line from the fourth location to the fifth location with the second value for the visual characteristic and displaying the portion of the route line from the fifth location to the third location with the first value for the visual characteristic.

8. The method of claim 7, wherein the first value for the visual characteristic includes a first visual emphasis less than a second visual emphasis of the second value for the visual characteristic.

9. An electronic device in communication with a display generation component, one or more output devices, and one or more input devices, the electronic device comprising:
one or more processors;
memory; and
one or more programs, wherein the one or more programs are stored in the memory and configured to be executed by the one or more processors, the one or more programs including instructions for:
while navigating along a first predefined route using a maps application, receiving, via the one or more input devices, an indication that one or more criteria are satisfied, including a first criterion that is satisfied when a current location of the electronic device is at least a threshold distance away from the first predefined route and a second criterion that is satisfied when the electronic device is moving towards a second location on the first predefined route that is more than a threshold route distance away from a first location on the first predefined route at which the electronic device deviated from the first predefined route to the current location of the electronic device;
in response to receiving the indication, displaying, via the display generation component, a selectable option to navigate to the first predefined route from the current location of the electronic device;
receiving, via the one or more input devices, an input selecting the selectable option; and
in response to receiving the input:
presenting navigation directions from the current location of the electronic device to a respective location on the first predefined route that is less than the threshold route distance away from the first location.

10. A non-transitory computer readable storage medium storing one or more programs, the one or more programs comprising instructions, which when executed by one or more processors of an electronic device in communication with a display generation component and one or more input devices, cause the electronic device to perform a method comprising:
while navigating along a first predefined route using a maps application, receiving, via the one or more input devices, an indication that one or more criteria are satisfied, including a first criterion that is satisfied when a current location of the electronic device is at least a threshold distance away from the first predefined route and a second criterion that is satisfied when the electronic device is moving towards a second location on the first predefined route that is more than a threshold route distance away from a first location on the first predefined route at which the electronic device deviated from the first predefined route to the current location of the electronic device;
in response to receiving the indication, displaying, via the display generation component, a selectable option to navigate to the first predefined route from the current location of the electronic device;
receiving, via the one or more input devices, an input selecting the selectable option; and
in response to receiving the input:
presenting navigation directions from the current location of the electronic device to a respective location on the first predefined route that is less than the threshold route distance away from the first location.

11-50. (canceled)
